(19) United States
(12) Patent Application Publication
(10) Pub. No.: US 2007/0038661 A1
(43) Pub. Date: Feb. 15, 2007

(54) Data structure of menu display control data and menu display device

(76) Inventor: Junya Kaku, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/542,005

(22) PCT Filed: Jan. 19, 2004
(86) PCT No.: PCT/JP04/00384

§ 371 Date: Jul. 12, 2005

(30) Foreign Application Priority Data
Jan. 21, 2003 (JP) 2003-011857
Jan. 21, 2003 (JP) 2003-011858

(51) Int. Cl. G06F 17/00

(52) U.S. Cl. 707/102

(57) ABSTRACT

A display control table comprises GUI tables <guitbl>[0] to <guitbl>[N-1] and menu tables <menu_tbl>[0] to <menu_tbl>[I-1] belonging to each of the GUI tables. Each of the GUI tables <guitbl>[0] to <guitbl>[N-1] manages a plurality of large items subjected to a display process. Also, each of the menu tables <menu_tbl>[0] to <menu_tbl>[I-1] manages a plurality of small items subjected to a display process. Assigned to each of the menu tables <menu_tbl>[0] to <menu_tbl>[I-1] are tree tables <tree_tbl>[0] to <tree_tbl>[L-1] indicative of dependency relationships with small items managed under the other GUI tables. When a desired small item is selected, a plurality of small items dependent on the desired small item are subjected to a display process, based on these tree tables <tree_tbl>[0] to <tree_tbl>[L-1].

### TECHNICAL FIELD

The present invention relates to a data structure of menu display control data. More specifically, the present invention relates to a data structure of menu display control data which is read out by a processor of a display device displaying menu images.

The present invention also relates to a menu display device and, more specifically, to a menu display device comprising a display means for displaying menu images based on menu display control data.

### PRIOR ART

In such a kind of display device, menu display control data and control program suitable thereto are written into a built-in memory in the manufacturing stage. Accordingly, if only the menu display control data is changed at the stage of use, the control program cannot properly process the changed menu display control data, thereby causing some defects in menu display. For this reason, it is conventionally impossible to change a menu image at the stage of use.

However, if the menu image cannot be changed according to variations in usage situation of the display device, the display device lacks versatility and causes some problem cost-wise. For example, taking a digital camera to which detailed information on a photographing site can be input, the detailed information to be input differs depending on whether the object scene is the manufacturing site of musical instruments or the building site of a house. If the menu image is fixed in such a case, it is necessary to prepare a digital camera dedicated for each photographing site, resulting in additional costs.

### SUMMARY OF THE INVENTION

Therefore, it is a primary object of the present invention to provide a data structure of menu display control data which allows a display device to display different menu images.

It is another object of the present invention to provide a menu display device which can display different menu images.

According to the present invention, a data structure of menu display control data that is read out by a processor of a display device displaying a menu image comprises a plurality of first management tables each of which manages a plurality of large items to be subjected to a display process by the processor, and a plurality of second management tables which manage a plurality of small items belonging to each of the plurality of first management tables and each of which is to be subjected to a display process by the processor. The data structure is characterized in that dependency relationship information indicative of a dependency relationship with a small item managed under a first management tables different from the first management table to which the noticed second management table belongs is assigned to the noticed second management table and, so that, when a desired small item is selected, the processor can display a plurality of small items dependent on the desired small item, based on the dependency relationship information.

The menu control data read out by the processor of the display device comprises the plurality of first management tables and the plurality of second management tables belonging to each of the same. Each of the plurality of first management tables manages the plurality of large items to be subjected to a display process by the processor. Also, each of the second management tables manages the plurality of small items to be subjected to a display process by the processor.

The dependency relationship information indicative of a dependency relationship with a small item managed under a first management table different from the first management table to which the second management table belongs is assigned to the noticed second management table. When a desired small item is selected, the processor displays a plurality of small items dependent on the desired small item, based on the dependency relationship information.

As stated above, since the dependency relationship information is assigned to the second management table, the processor can accurately display the small items on a screen by reading the dependency relationship information. More specifically, the display device can display different menu images on the screen using the common procedure.

Preferably, desired small item information indicative of the desired small item is assigned to the first management table managing the desired small item. The processor displays the desired small item instead of the large item corresponding to the desired small item based on the desired small item information. This makes it possible to easily grasp which small item is selected, thereby improving operability.

More preferably, when the desired small item is deselected, the desired small item information is switched to small item unselected information. The processor displays a large item corresponding to the desired small item instead of the desired small item, based on the small item unselected information.

Preferably, unselectable information is assigned to the first management table to which a second management table dependent on the small item of the second management table in which the desired small item is not selected belongs. The processor suspends display of the large items managed by the first management table to which the unselectable information is assigned. This makes it possible to stop display of large items related to the unselected small items, which results in operability enhancement.

Preferably, the dependency relationship information may be indicative of dependency relationships with a plurality of small items. In this case, the number of the second management table is decreased, which leads to data size reduction.

Preferably, the plurality of second management tables belonging to each of the plurality of the first management tables form a sequence. At this time, leading position information and number-of-tables information of the plurality of second management tables are assigned to each of the plurality of the first management tables. This eliminates the need for assigning address information to each of the second management tables, and makes it possible to reduce data size.

According to the present invention, a menu display device comprising a display means for displaying a menu image based on menu display control data, is characterized in that the menu display control data includes a plurality of first management tables that each manage a plurality of large items and a plurality of second management tables that belong to each of the plurality of first management tables and each of which manages a plurality of small items, each of the plurality of second management tables is assigned to dependency relationship information indicative of a dependency relationship with a small item managed under a first management table different from the first management table to which the second management table belongs, and the display means includes a specifying means that, when a desired small item is selected, specifies a plurality of small items dependent on the desired small item, based on the dependency relationship information.

The menu display control data includes the plurality of first management tables and the plurality of second management tables. Each of the plurality of first management tables manages a plurality of large items. Also, the plurality of second management tables include a plurality of second management tables which belong to each of the plurality of first management tables and each of which manages a plurality of small items. Dependency relationship information indicative of a dependency relationship with a small item managed under a first management table different from the first management table to which the second management table belongs, is assigned to each of the plurality of second management tables.

In displaying a menu image based on the menu display control data, when a desired small item is selected, the display means specifies a plurality of small items dependent on the desired small item based on the dependency relationship information.

As described above, the dependency relationship information is assigned to the second management tables, allowing small items to be accurately displayed by reading the dependency relationship information. That is, it is possible to display different menu images on the screen using the common procedure.

Preferably, the display means assigns the desired small item information indicative of a desired small item to a first management table managing the desired small item, and displays the desired small item instead of a large item corresponding to the desired small item based on the desired small item information. This makes it easy to grasp which small item is selected, resulting in an improvement in operability.

More preferably, when the desired small item is deselected, the display means switches from the desired small item information to the small item unselected information, and displays a large item corresponding to the desired small item instead of the desired small item, based on the small item unselected information.

Preferably, the display means assigns the unselectable information to the first management table to which a second management table dependent on the small items of the second management table in which the desired small item is not selected belongs, and suspends display of the large items managed by the first management table to which the unselectable information is assigned.

Preferably, when an object is photographed by a photographing means, an image file containing an image signal of this object and menu information including the desired small item is created by a creation means.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view showing one part of a menu structure applied to the FIG. 1 embodiment;

FIG. 3 is an illustrative view showing another part of the menu structure applied to the FIG. 1 embodiment;

FIG. 4 is an illustrative view showing still another part of the menu structure applied to the FIG. 1 embodiment;

FIG. 5 is an illustrative view describing names of elements forming the menu structure;

FIG. 6 is an illustrative view showing one example of transition of screen display;

FIG. 7 (A) is an illustrative view showing one example of a menu displayed on a screen;

FIG. 7 (B) is an illustrative view showing another example of the menu displayed on the screen;

FIG. 8 (A) is an illustrative view showing still another example of the menu displayed on the screen;

FIG. 8 (B) is an illustrative view showing further another example of the menu displayed on the screen;

FIG. 9 (A) is an illustrative view showing another example of the menu displayed on the screen;

FIG. 9 (B) is an illustrative view showing still another example of the menu displayed on the screen;

FIG. 10 (A) is an illustrative view showing further another example of the menu displayed on the screen;

FIG. 10 (B) is an illustrative view showing another example of the menu displayed on the screen;

FIG. 11 (A) is an illustrative view showing still another example of the menu displayed on the screen;

FIG. 11 (B) is an illustrative view showing further another example of menu displayed on the screen;

FIG. 12 (A) is an illustrative view showing another example of menu displayed on the screen;

FIG. 12 (B) is an illustrative view showing still another example of menu displayed on the screen;

FIG. 13 (A) is an illustrative view showing further another example of menu displayed on the screen;

FIG. 13 (B) is an illustrative view showing another example of menu displayed on the screen;

FIG. 14 (A) is an illustrative view showing still another example of menu displayed on the screen;

FIG. 14 (B) is an illustrative view showing further another example of menu displayed on the screen;

FIG. 15 is an illustrative view showing one example of a display control table corresponding to the menu structures shown in FIG. 2 to FIG. 4;

FIG. 16 is an illustrative view showing one example of a structure of the display control table shown in FIG. 15;

FIG. 17 is an illustrative view showing one example of character string data corresponding to the menu structures shown in FIG. 2 to FIG. 4;

FIG. 18 is an illustrative view showing one example of a mapping state of an SDRAM applied to the FIG. 1 embodiment;

FIG. 19 is an illustrative view showing one example of a mapping state of a flash memory applied to the FIG. 1 embodiment;

FIG. 20 is a flowchart showing one part of an operation of the FIG. 1 embodiment;

FIG. 21 is a flowchart showing another part of the operation of the FIG. 1 embodiment;

FIG. 22 is a flowchart showing still another part of the operation of the FIG. 1 embodiment;

FIG. 23 is a flowchart showing further another part of the operation of the FIG. 1 embodiment;

FIG. 24 is a flowchart showing another part of the operation of the FIG. 1 embodiment;

FIG. 25 is a flowchart showing still another part of the operation of the FIG. 1 embodiment;

FIG. 26 is a flowchart showing further another part of the operation of the FIG. 1 embodiment;

FIG. 27 is a flowchart showing another part of the operation of the FIG. 1 embodiment;

FIG. 28 is a flowchart showing still another part of the operation of the FIG. 1 embodiment;

FIG. 29 is a flowchart showing further another part of the operation of the FIG. 1 embodiment;

FIG. 30 is a flowchart showing another part of the operation of the FIG. 1 embodiment;

FIG. 31 is a flowchart showing still another part of the operation of the FIG. 1 embodiment;

FIG. 32 is a flowchart showing further another part of the operation of the FIG. 1 embodiment;

FIG. 33 is a flowchart showing another part of the operation of the FIG. 1 embodiment;

FIG. 34 is a flowchart showing still another part of the operation of the FIG. 1 embodiment;

FIG. 35 is a flowchart showing further another part of the operation of the FIG. 1 embodiment;

FIG. 36 is a flowchart showing another part of the operation of the FIG. 1 embodiment;

FIG. 37 is a flowchart showing still another part of the operation of the FIG. 1 embodiment;

FIG. 38 is a flowchart showing further another part of the operation of the FIG. 1 embodiment;

FIG. 39 is a flowchart showing another part of the operation of the FIG. 1 embodiment;

FIG. 40 is a flowchart showing still another part of the operation of the FIG. 1 embodiment;

FIG. 41 is a flowchart showing further another part of the operation of the FIG. 1 embodiment;

FIG. 42 is a flowchart showing another part of the operation of the FIG. 1 embodiment; and

FIG. 43 is a flowchart showing still another part of the operation of the FIG. 1 embodiment;

### BEST MODE FOR PRACTICING THE INVENTION

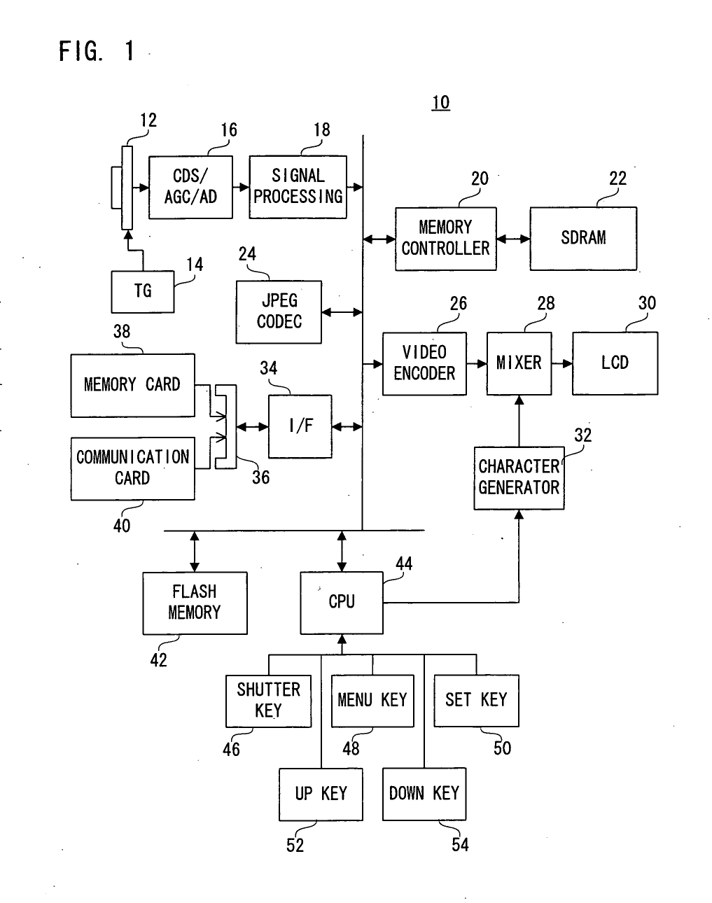

Referring to FIG. 1, a digital camera 10 of this embodiment is a camera used mainly for photographing a manufacturing site of musical instruments, and includes an image sensor 12. An optical image of an object scene, i.e., the manufacturing site is irradiated onto a light-receiving surface of the image sensor 12 via an optical lens (not illustrated). A plurality of light-receiving elements (not illustrated) are arranged on the light-receiving surface, and a raw image signal (electric charges) is generated by photoelectric conversion of these light-receiving elements corresponding to the optical image of the object scene.

When a shutter key 46 is operated, a photographing process is carried out. Firstly, a CPU 44 provides a TG (Timing Generator) 14 with an instruction for reading, provides a signal processing circuit 18 with an instruction for processing, and provides a JPEG codec 24 with an instruction for compression. The TG 14 supplies a timing signal to the image sensor 12 in order to read out the raw image signal generated in the light-receiving elements. The raw image signal is read out from the image sensor 12 in a raster scanning mode, and subjected to a series of processes, noise elimination, gain adjustment and A/D conversion, in a CDS/AGC/AD circuit 16. Raw image data output from the CDS/AGC/AD circuit 16 is subjected by the signal processing circuit 18 to signal processes such as color separation, white balance adjustment and YUV conversion. YUV data generated in this way is written into an SDRAM 22 by a memory controller 20.

The JPEG codec 24 reads out the YUV data from the SDRAM 22 through the memory controller 20, and subjects the read YUV data to JPEG compression. The compressed YUV data generated in this way, that is, JPEG data is also written into the SDRAM 22 by the memory controller 20.

The CPU 44 creates a file header by its own, reads out the JPEG data stored in the SDRAM 22 through the memory controller 20, and provides an I/F 34 with an image file containing the file header and the JPEG data. If a memory card 38 is attached to a slot 36, the image file is recorded by the I/F 34 on the memory card 38. If a communication card 40 is attached to the slot 36, the image file is given from the I/F 34 to the communication card 40, and transmitted by the communication card 40 to a remote server (not illustrated).

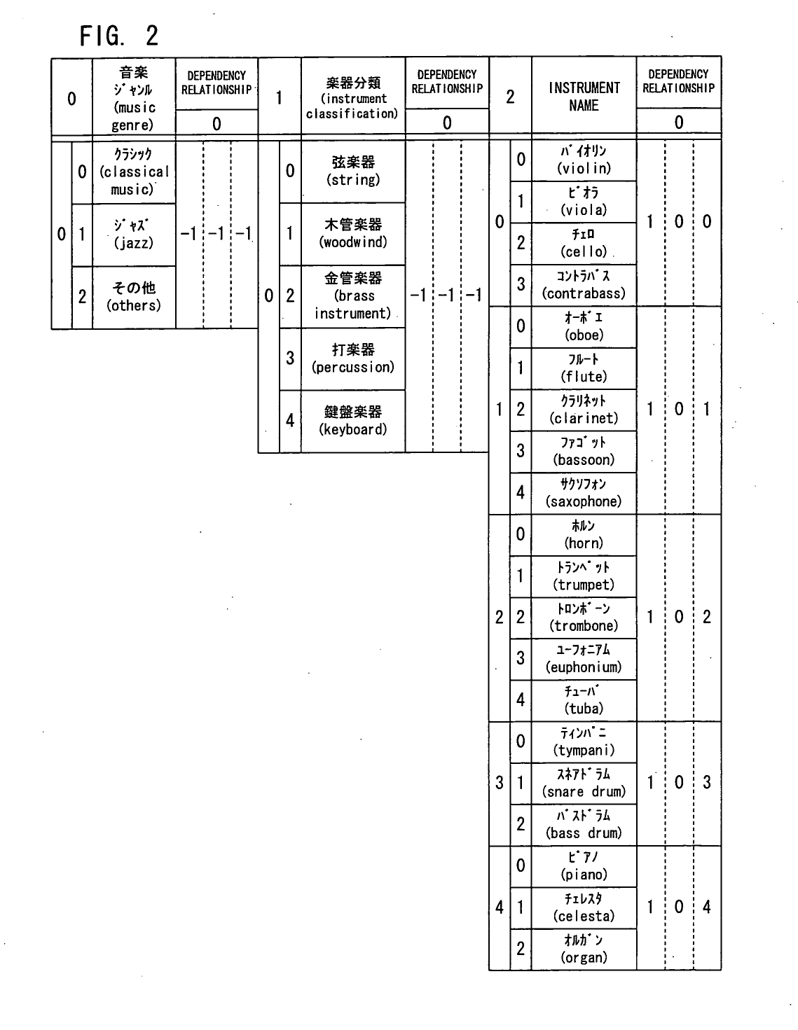

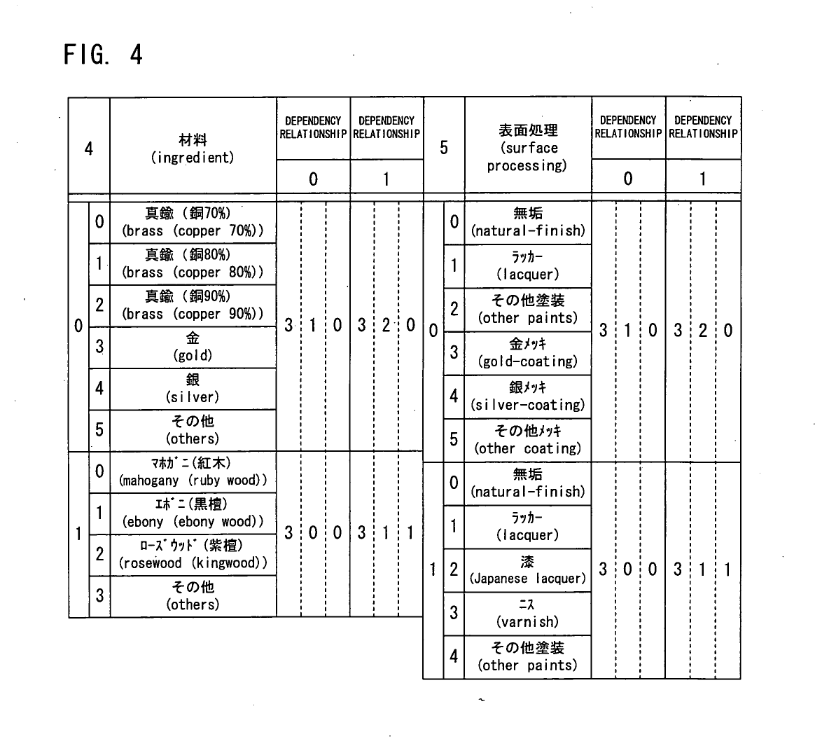

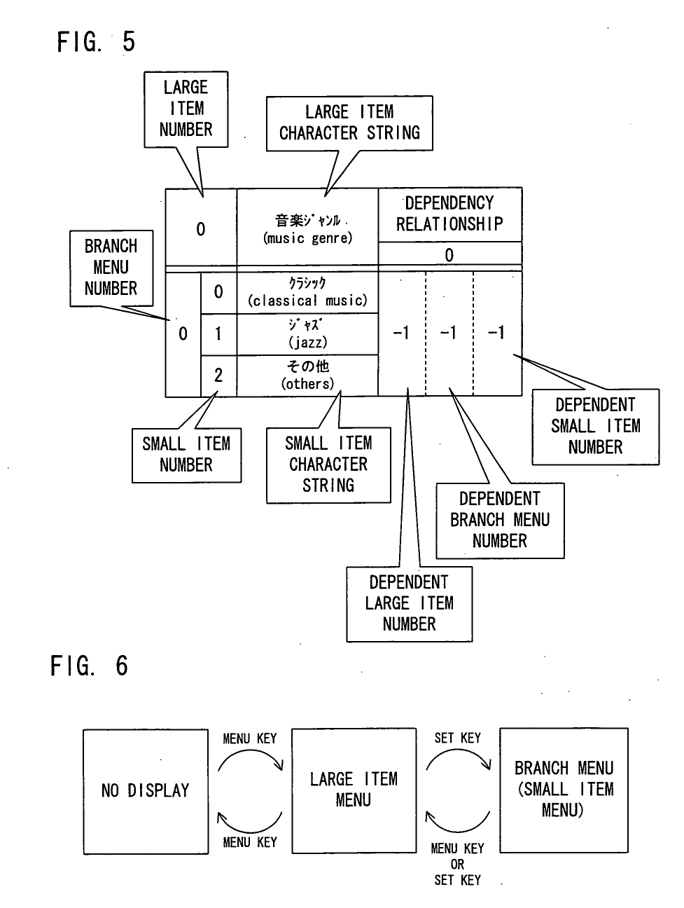

If a display control table and character string data described later are effective, a menu having the structure shown in FIG. 2 to FIG. 4 is displayed on an LCD 30 in response to operation of a menu key 46 and set key 50. More specifically, according to instruction from the CPU 44, a character generator 32 outputs desired character data. The output character data is provided to the LCD 30 via a mixer 28, which causes the menu to be displayed. In addition, names of elements forming a menu structure are shown in FIG. 5. Also, transitions between displayed menus according to key operation are shown in FIG. 6 to FIG. 14 (B). Operating these displayed menus makes it possible to input detailed information for identifying a manufacturing site of musical instruments.

Referring to FIG. 2 to FIG. 4, the menu structure is classified into six large items 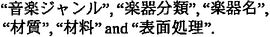
Large item numbers “0” to “5” are assigned to these six large items.

The item 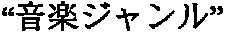
is classified into small items 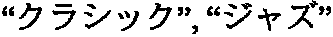
and 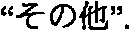
These small items all belong to a branch menu “0”. A small item number “0” is assigned to 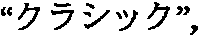
a small item number “1” is assigned to 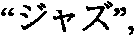
and a small item number “2” is assigned to

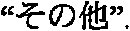

The item 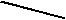
is classified into small items 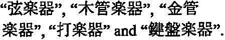
All of these small items also belong to the branch menu “0”. The small item number “0” is assigned to 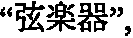
the small item number “1” is assigned to 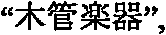
the small item number “2” is assigned to 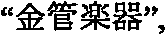
a small item number “3” is assigned to 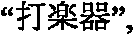
and a small item number “4” is assigned to

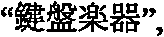

The item 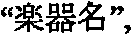
is classified into small items

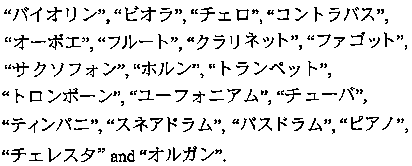

Among them, 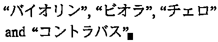
belong to a branch menu 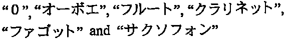
belong to a branch menu “1”. Also, 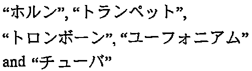
belong to a branch menu “2”, 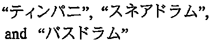
belong to a branch menu 3, and 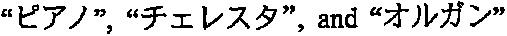
belong to a branch menu “4”.

The small item number “0” is assigned to 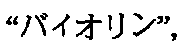
the small item number “1” is assigned to 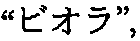
the small item number “2” is assigned to 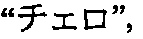
and the small item number “3” is assigned to 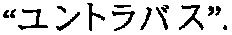
The small item number “0” is assigned to 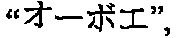
the small item number “1” is assigned to 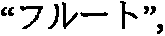
The small item number “2” is assigned 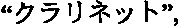
and the small item number “3” is assigned to 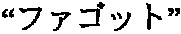
and the small item number “4” is assigned to

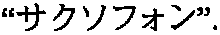

The small item number “0” is assigned to 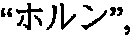
the small item number “1” is assigned to 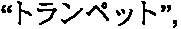
the small item number “2” is assigned 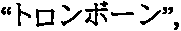
the small item number “3” is assigned to 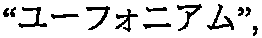
and the small item number “4” is assigned to 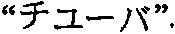
The small item number “0” is assigned to 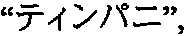
the small item number “1” is assigned to 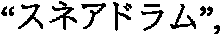
and the small item number “2” is assigned to 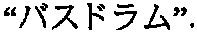
The small item number “0” is assigned to 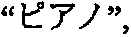
the small item number “1” is assigned to 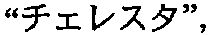
and the small item number “2” is assigned to

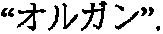

The item 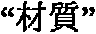
is classified into small items 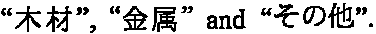
The item 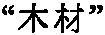
belongs to the branch menus “0” and “1”, 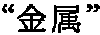
belongs to the branch menus “1” and “2”, and 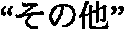
belongs to the branch menus “0”, “1” and “2”. The small item number “0” is assigned to 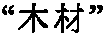
belonging to the branch menu “0”. The small item number “1” is assigned to 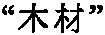
belonging to the branch menu “1”. The small item number “0” is assigned to 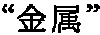
belonging to the branch menu “1”, and the small item number “0” is assigned to 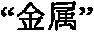
belonging to the branch menu “2”. The small item number “1” is assigned to 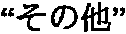
belonging to the branch menu “0”, and the small item number “2” is assigned to 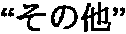
belonging to the branch menu “1”, and the small item number “1” is assigned to 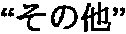
belonging to the branch menu “2”.

The item 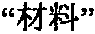
is classified into small items 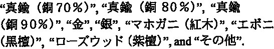
The items 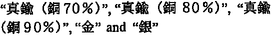
belong to the branch menu “0”. The items 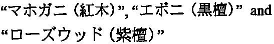
belong to the branch menu “1”. The item 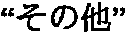
belongs to the branch menus “0” and “1”.

The small item number “0” is assigned to 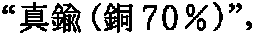
the small item number “1” is assigned to 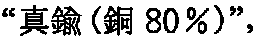
and the small item number “2” is assigned to 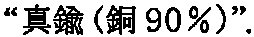
The small item “3” is assigned to 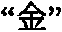
and the small item number “4” is assigned to 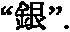
The small item number “5” is assigned to 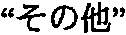
belonging to the branch menu “0”. The small item number “0” is assigned to 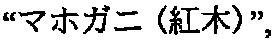
the small item number “1” is assigned to the 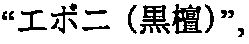
and the small item number “2” is assigned to 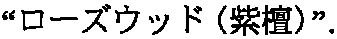
The small item number “3” is assigned to 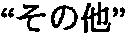
belonging to the branch menu “1”.

The 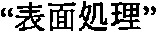
is classified into small item 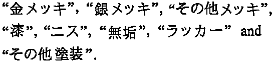
The items 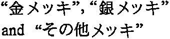
belong to the branch menu “0”, and the items 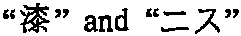
belong to the branch menu “1”. Each of the items 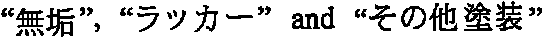
belongs to the branch menus “0” and “1”.

The small item number “3” is assigned to 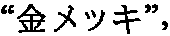
the small item number “4” is assigned to 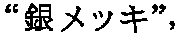
and the small item number “5” is assigned to 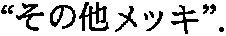
The small item number “2” is assigned to 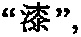
the small item number “3” is assigned to 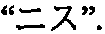
In both the branch menus “0” and “1”, the small item number “0” is assigned to 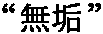
and the small item number “1” is assigned to 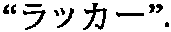
On the contrary, the small item number “2” is assigned to 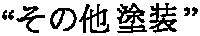
belonging to the branch menu “0”, and the small item number “4” is assigned to 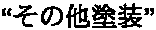
belonging to the branch menu “1”.

Three numbers indicative of relationships with another small item are assigned to each of the branch menus. Among them, the leftmost number is a number for a dependent large item, the middle number is a number for a dependent branch menu, and the rightmost number is a number for a dependent small item. Incidentally, “−1” denotes that there is no dependency relationship. Accordingly, the branch menu “0” belonging to 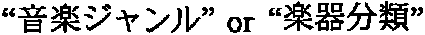
is not dependent on any small items.

On the contrary, for 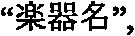
the branch menu “0” is dependent on 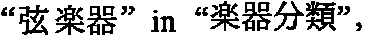
the branch menu “1” is dependent on 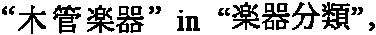
the branch menu “2” is dependent on 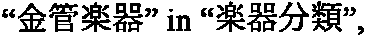
the branch menu “3” is dependent on 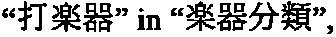
and the branch menu “4” us dependent on

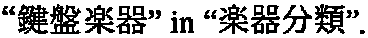

Regarding 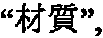
the branch menu “0” is dependent on 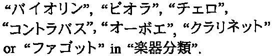
In addition, the branch menu “1” is dependent on 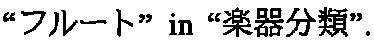
Moreover, the branch menu “2” is dependent on

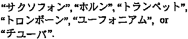

As for 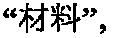
the branch menu “0” is dependent on 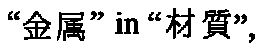
and the branch menu “1” is dependent on 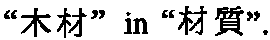
For 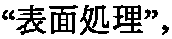
the branch menu “0” is dependent on 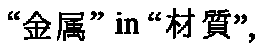
and the branch menu “1” is dependent on

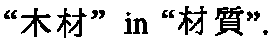

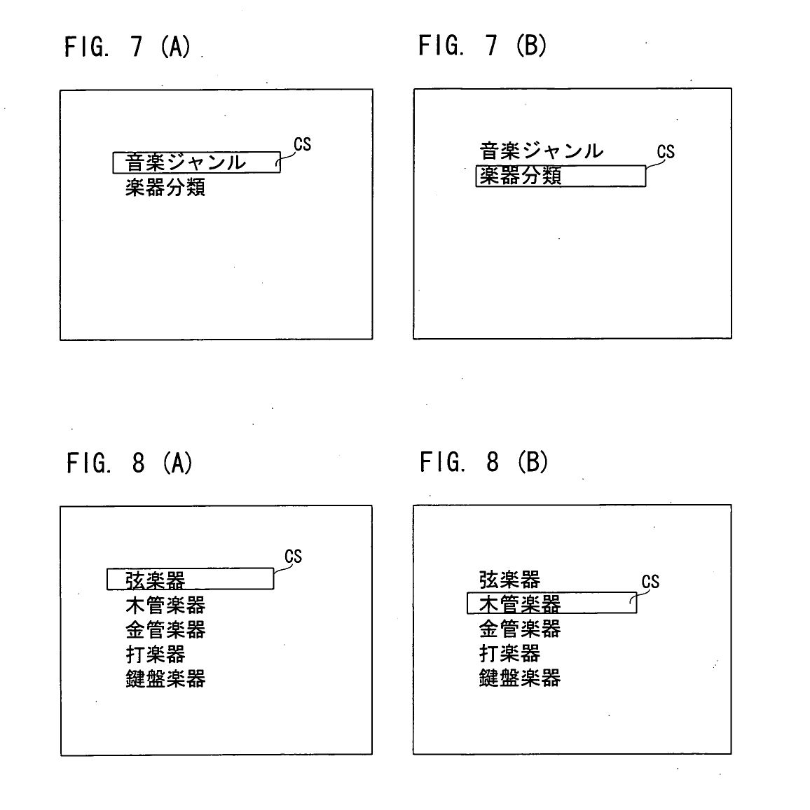

When a menu key 48 is operated in a state where menu display is turned off, a large item menu shown in FIG. 7(A) is displayed on the LCD 30. According to FIG. 7(A), character strings 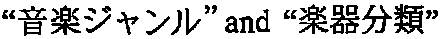
are displayed in middle of the screen, and 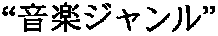
is pointed at by a cursor CS. The cursor CS moves upward in response to operation of an up key 52 and moves downward in response to operation of a down key 54. Additionally, the reason why large items other than 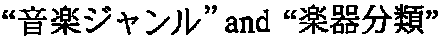
are not displayed at this timing is that, due to the above described dependency relationships, selection of a small item related to 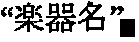
should not be permitted unless a small item belonging to 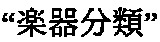
is selected, and selection of a small item related to 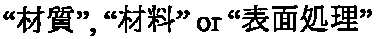
should not be permitted unless a small item belonging to 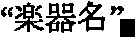
is selected.

If the down key 54 is operated once in the state shown in FIG. 7 (A), the cursor CS points at 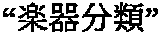
as shown in FIG. 7 (B). When a set key 50 is operated in the state where the cursor CS is pointing at 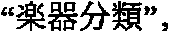
screen display changes from the large menu shown in FIG. 7 (B) to a branch shown in FIG. 8 (A). According to FIG. 8 (A), character strings 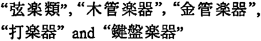
that denote the small items belonging to 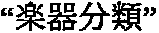
are displayed in the center of the screen. The cursor CS points at 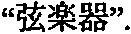
When the down key 54 is operated once in this state, the small item pointed at the cursor CS is moved to 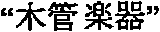
as shown in FIG. 8 (B).

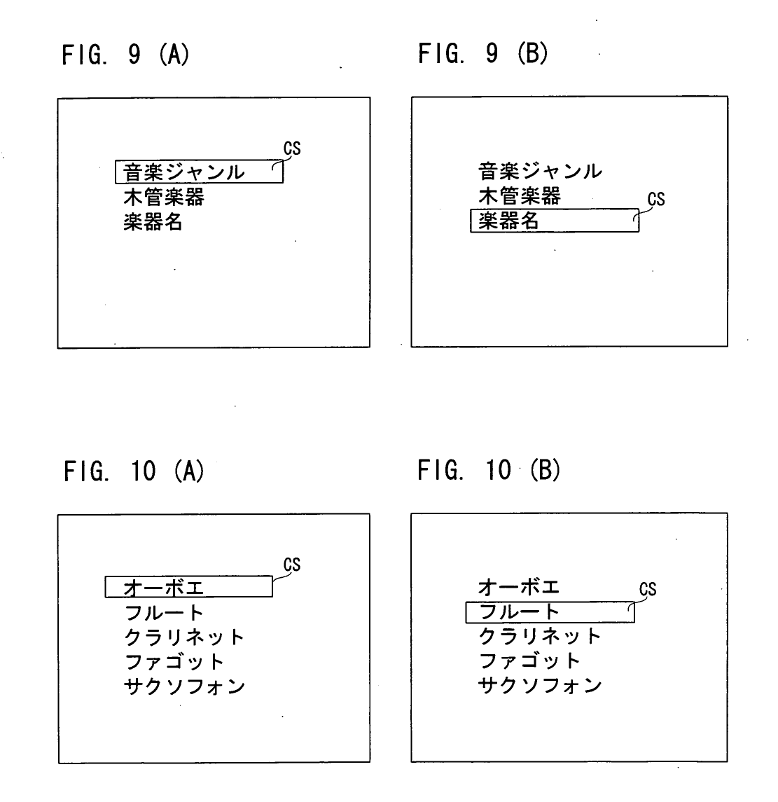

When the set key 50 is operated in the state where the cursor CS is pointing at 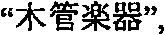
screen display changes from the branch menu shown in FIG. 8 (B) to a large item menu shown in FIG. 9 (A). According to FIG. 9 (A), the character string 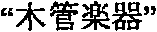
is displayed in place of the character string 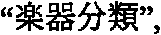
and the character string 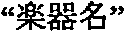
is displayed thereunder. This makes it possible to find that 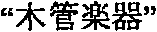
is selected in 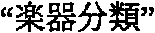
and that selection of a small item belonging to 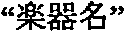
is prompted. Since no small item belonging to 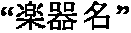
is specified at this timing, the large items 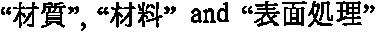
are not yet displayed. Incidentally, if the menu key 48 is operated when the branch menu shown in FIG. 8 (B) is displayed, screen display returns to the large item menu shown in FIG. 7 (B).

When the set key 50 is operated in the state where the cursor CS is put on 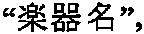
moving from 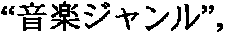
by using the down key 54, screen display changes from the large item menu shown in FIG. 9 (B) to a branch menu shown in FIG. 10 (A). According to FIG. 10 (A), character strings 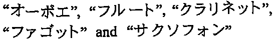
belonging to the branch menu “0” of 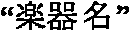
are displayed in the center of the screen. The reason why these character strings are displayed is that numbers “1”, “0” and “1” indicative of a dependency relationship with 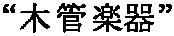
shown in FIG. 2 is assigned to the branch menu “0”. Incidentally, the cursor CS points at

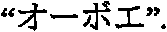

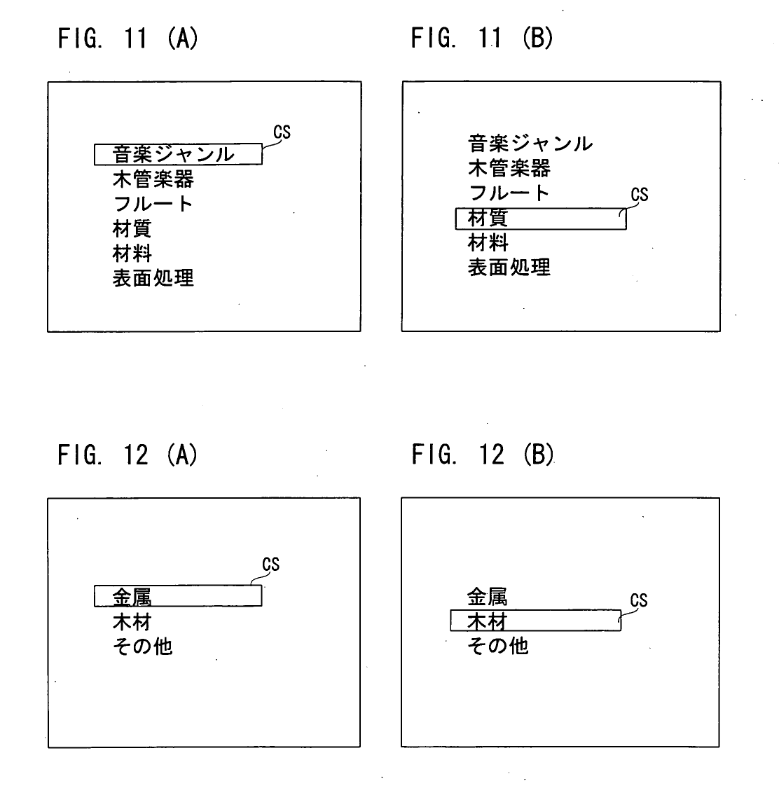

Under this state, when the cursor CS is put on 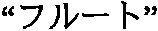
by using the down key 54 and the set key 50 is operated, screen display changes from the branch menu shown in FIG. 10 (B) to a large item menu shown in FIG. 11 (A). According to FIG. 11 (A), the character string 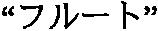
is displayed in place of the character string 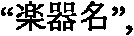
and the character strings 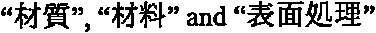
are displayed thereunder. From this, it can be understood that 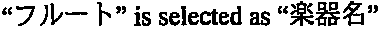
and that selection of a small item belonging to each of 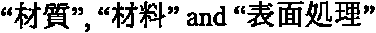
is prompted. Additionally, if the menu key 48 is pressed instead of the set key 50, screen display returns from the branch menu shown in FIG. 10 (B) to the large item menu shown in FIG. 9 (B).

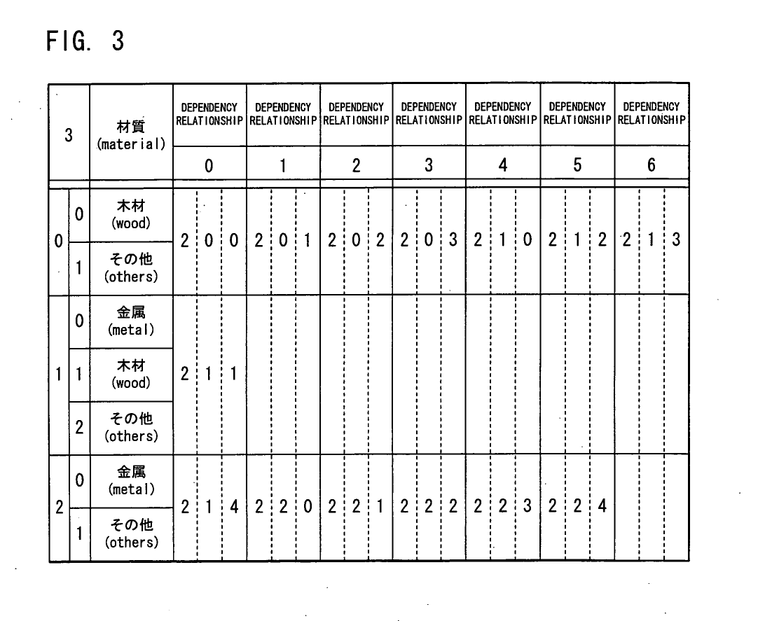

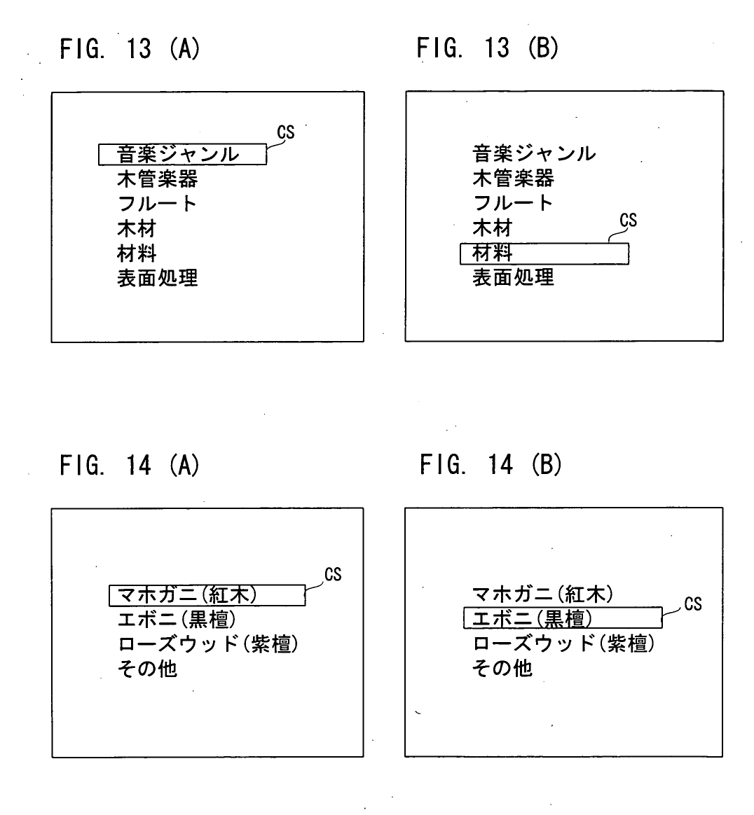

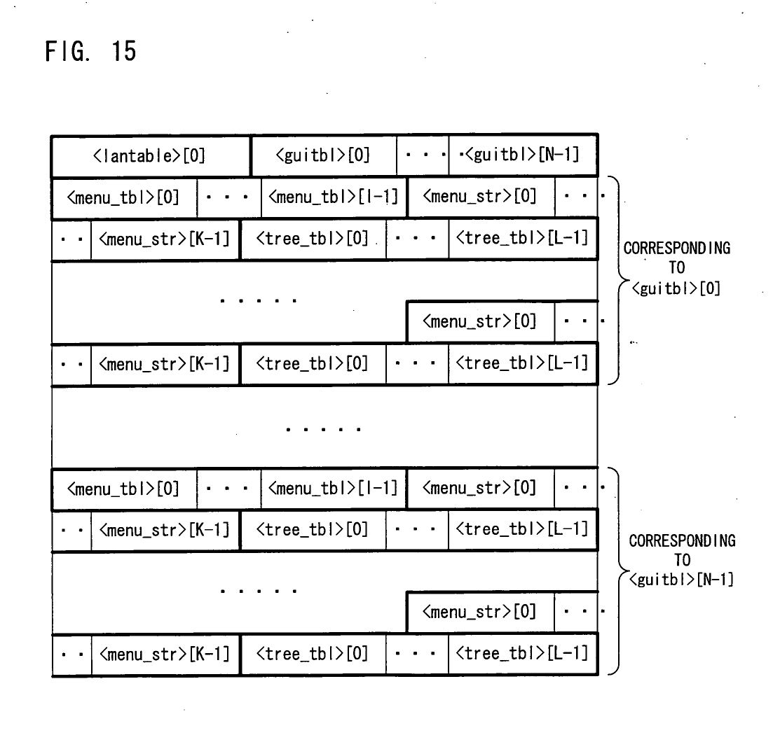

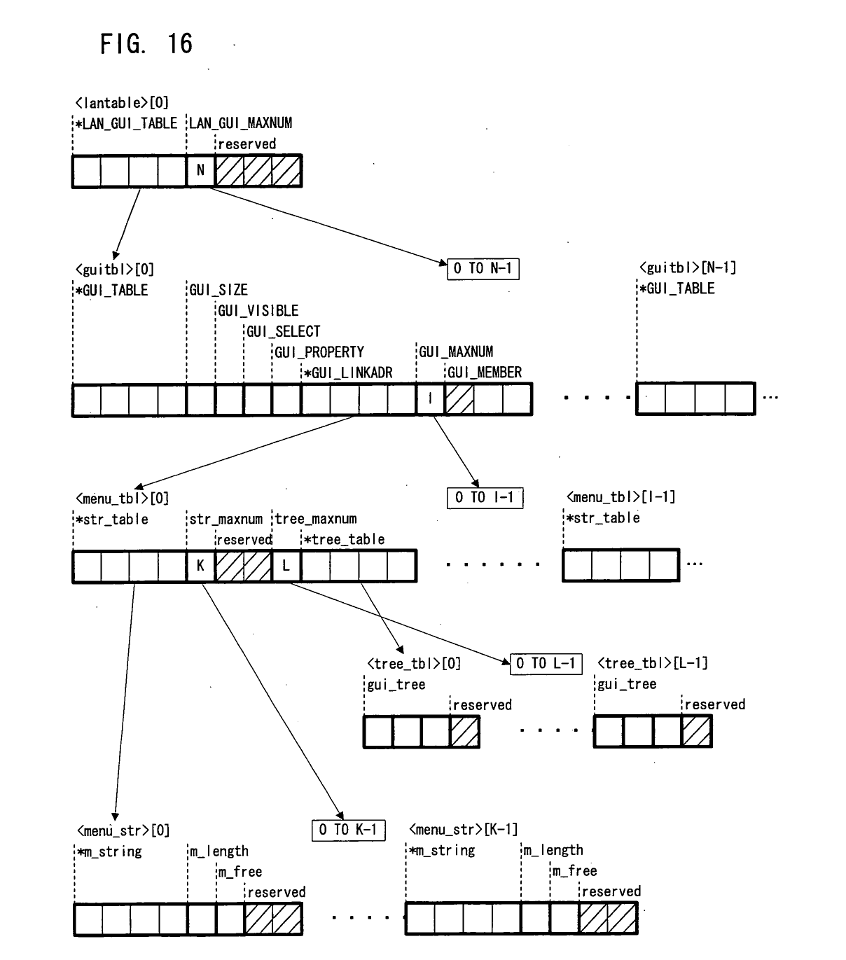

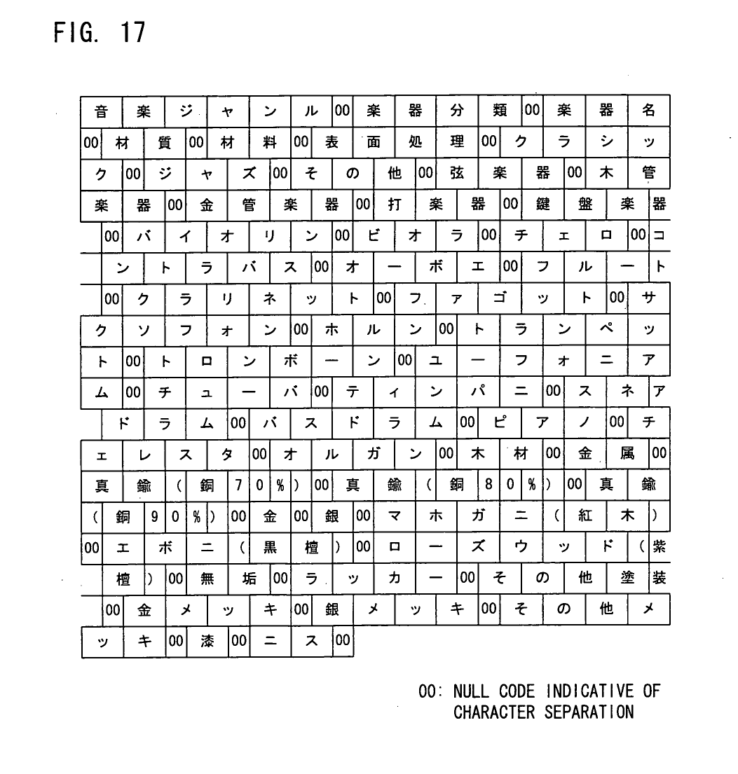

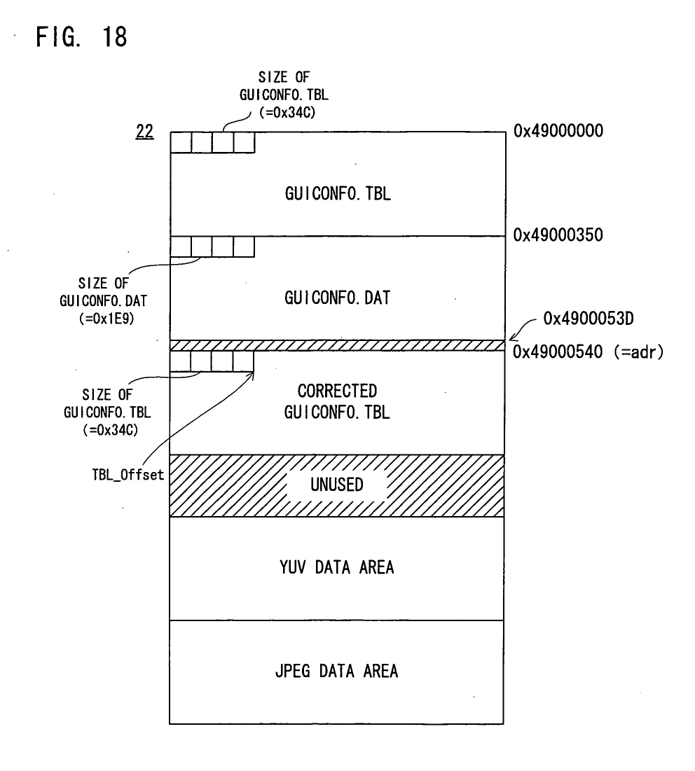

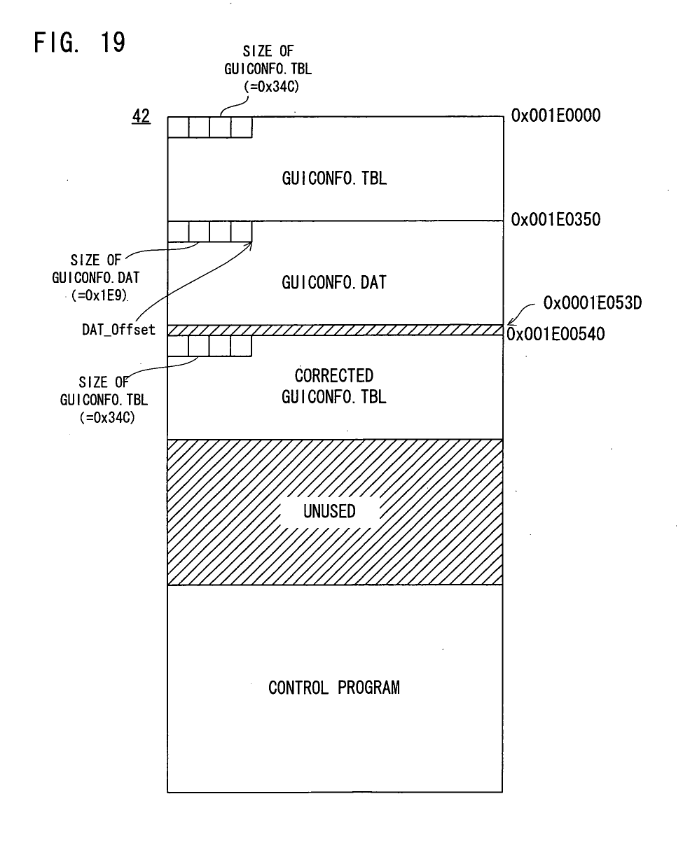

When the set key 50 is operated in a state where the cursor CS is put on 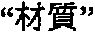
by using the down key 54, screen display changes from the large item menu of FIG. 11 (B) to a branch menu shown in FIG. 12 (A). According to FIG. 12 (A), the character strings 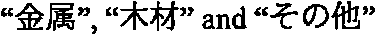
that denote small items belonging 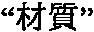
are displayed in the center of the screen. The reason why these small items are displayed is that the numbers “2”, “1” and “1” indicative of a dependency relationship with 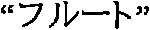
shown in FIG. 2 are assigned to 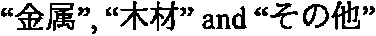
shown in FIG. 3.

When the cursor CS is put on 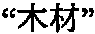
by using the down key 54 and the set key 50 is operated here, screen display changes from a branch menu shown in FIG. 12 (B) to a large item menu shown in FIG. 13 (A). According to FIG. 13 (A), the character string 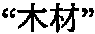
is displayed in place of the character string 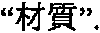
It is clear from this that 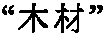
is selected as 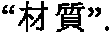
Incidentally, if the menu key 48 is pressed instead of the set key 50, screen display is returned from the branch menu shown in FIG. 12 (B) to the large item menu shown in FIG. 11 (B).

When the cursor CS is put on 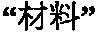
by using the down key 54 and the set key 50 is operated, screen display shifts from a large item menu shown in FIG. 13 (B) to a branch menu in FIG. 14 (A). According to FIG. 14 (A), the character strings 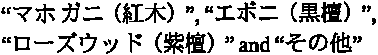
that denote the small items belonging to 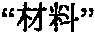
are displayed on the center of the screen. The reason why these small items are displayed is that the numbers “3”, “1” and “1” indicative of a dependency relationship with 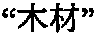
shown in FIG. 3 are assigned to 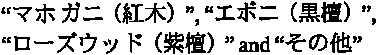
shown in FIG. 4.

In the branch menu resented in FIG. 14 (A), the cursor CS points at 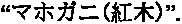
When the down key 54 is operated here, the cursor CS moves so as to point at 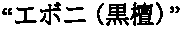
as shown in FIG. 14 (B). By repeating this key operation, a desired small item is selected under each of the large items. In addition, it is not necessary to select a small item with respect to all the large items. A blank is left for the large item on which no small item is selected.

These input operations of detailed information are carried out in advance of operation of the shutter key 46. The input detailed information is embedded in the header of an image file created in response to the operation of the shutter key 46. This makes it possible to accurately grasp what musical instrument is being manufactured, based on the photographed image and the detailed information.

Subsequently, a description will be given below as to structures of a display control table and character string data used for input of detailed information, referring to FIG. 15 to FIG. 17. A display control table GUICONF0.TBL has a structure shown in FIG. 15 and FIG. 16, and character string data GUICONF0.DAT has a structure shown in FIG. 17.

Referring to FIG. 15 and FIG. 16, the display control table GUICONF0.TBL includes one LAN table <lantable>[0] and N consecutive GUI tables <guitbl>[0] to <guitble>[N-1]. I consecutive branch menu tables <menu_tbl>[0] to <menu_tbl>[I-1] are assigned to each of the GUI tables <guitbl>[0] to <guitble>[N-1]. Also, K consecutive menu strings <menu_str>[0] to <menu_str>[K-1] and L consecutive tree tables <tree_tbl>[0] to <tree_tbl>[L-1] are assigned to each of the branch menu tables <menu_tbl>[0] to <menu_tbl>[I-1].

The GUI table is prepared for each of the large items shown in FIG. 2 to FIG. 4. As stated above, there exists the six large items 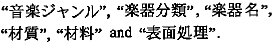
Accordingly, the GUI tables <guitbl>[0] to <guitbl>[5] are prepared in the display control table GUICONF0.TBL.

The branch menu table is prepared for each of the branch menus shown in FIG. 2 to FIG. 4. Since 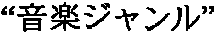
has one branch menu, the branch menu <menu_tbl>[0] alone is assigned to the GUI table <guitbl>[0]. Also, 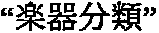
has one branch menu and thus the branch menu <menu_tbl>[0] alone is assigned to the GUI table <guitbl>[1]. The item 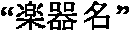
has four branch menus and thus the branch menus <menu_tbl>[0] to <<menu_tbl>[3] are assigned to the GUI table <guitbl>[2]. The item 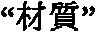
has three branch menus and thus the branch menus <menu_tbl>[0] to <menu_tbl>[2] are assigned to the GUI table <guitbl>[3]. The item 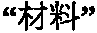
has two branch menus and thus the branch menu tables <menu_tbl>[0] to <menu_tbl>[1] are assigned to the GUI table <guitbl>[4]. Also, 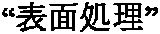
has the two branch menus and thus the branch menu tables <menu_tbl>[0] to <menu_tbl>[1] are assigned to the GUI table <GUITBL>[5].

The menu string is prepared for each of the small items shown in FIG. 2 to FIG. 4. For 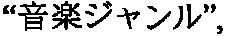
the three small items 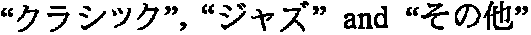
belong to the branch menu “0”. Accordingly, the menu strings <menu_str>[0] to <menu_str>[2] are assigned to the branch menu table <menu_tbl>[0] belonging to the GUI table <guitbl>[0]. With regard to 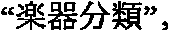
the four small items 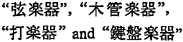
belong to the branch menu “0”. Thus, the menu strings <menu_str>[0] to <menu_str>[3] are assigned to the branch menu table <menu_tbl>[0] belonging to the GUI table <guitbl>[1].

As for 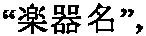
the four small items 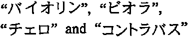
belong to the branch menu “0”, and the five small items 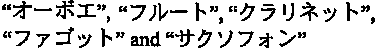
belong to the branch menu “1”. Also, the five small items 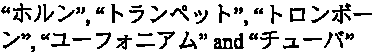
belong to the branch menu “2”, the three small items 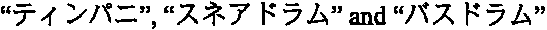
belong to the branch menu “3”, and the three small items 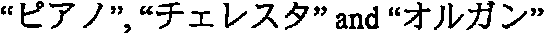
belong to the branch menu “4”.

Accordingly, the menu strings <menu_str>[0] to <menu_str>[3] are assigned to the branch menu table <menu_tbl>[0] belonging to the GUI table <guitbl>[2], and the menu strings <menu_str>[0] to <menu_str>[4] are assigned to the branch menu table <menu_tbl>[1] belonging to the GUI table <guitbl>[2]. Also, the menu strings <menu_str>[0] to <menu_str>[4] are assigned to the branch menu table <menu_tbl>[2] belonging to the GUI table <guitbl>[2], the menu strings <menu_str>[0] to <menu_str>[2] are assigned to the branch menu table <menu_tbl>[3] belonging to the GUI table <guitbl>[2], and the menu strings <menu_str>[0] to <menu_str>[2] are assigned to the branch menu table <menu_tbl>[4] belonging to the GUI table <guitbl>[2].

With regard to 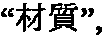
the two small items 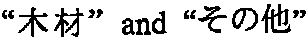
belong to the branch menu “0”, the three small item 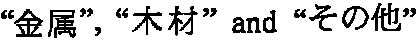
belong to the branch menu “1”, and the two small items 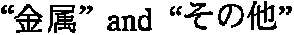
belong to the branch menu “2”. Thus, the menu strings <menu_str>[0] to <menu_str>[1] are assigned to the branch menu table <menu_tbl>[0] belonging to the GUI table <guitbl>[3], the menu strings <menu_str>[0] to <menu_str>[2] are assigned to the branch menu table <menu_tbl>[1] belonging to the GUI table <guitbl>[3], and the menu strings <menu_str>[0] to <menu_str>[1] are assigned to the branch menu table <menu_tbl>[2] belonging to the GUI table <guitbl>[3].

For 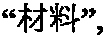
the six small items 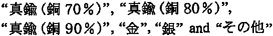
belong to the branch menu “0”, and the four small items 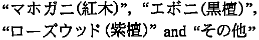
belong to the branch menu “1”. Accordingly, the menu strings <menu_str>[0] to <menu_str>[5] are assigned to the branch menu table <menu_tbl>[0] belonging to the GUI table <guitbl>[4], and the menu strings <menu_str>[0] to <menu_str>[3] are assigned to the branch menu table <menu_tbl>[1] belonging to the GUI table <guitbl>[4].

For 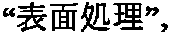
the six small items 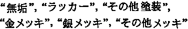
belong to the branch menu “0”, and the five small items 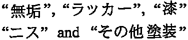
belong to the branch menu “1”. Consequently, the menu strings <menu_str>[0] to <menu_str>[5] are assigned to the branch menu table <menu_tbl>[0] belonging to the GUI table <guitbl>[5], and the menu strings <menu_str>[0] to <menu_str>[4] are assigned to the branch menu table <menu_tbl>[1] belonging to the GUI table <guitbl>[5].

The tree table is prepared for each of the dependency relationships shown in FIG. 2 to FIG. 4. The branch menu “0” is provided to 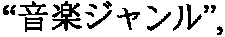
and one dependency relationship exists under the branch menu “0”. Therefore, the tree table <tree_tbl>[0] is assigned to the branch menu table <menu_tbl>[0] belonging to the GUI table <guitbl>[0]. The branch menu “0” is also provided to 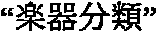
and one dependency relationship exists under the branch menu “0”. Accordingly, the tree table <tree_tbl>[0] is assigned to the branch menu table <menu_tbl>[0] belonging to the GUI table <guitbl>[1]. The branch menus “0” to “4” are provided to 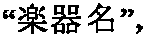
and one each dependency relationship exists under these branch menus “0” to “4”. Thus, the tree table <tree_tbl>[0] is assigned to each of the branch menu tables <menu_tbl>[0] to <menu_tbl>[4] belonging to the GUI table <guitbl>[2].

The branch menus “0” to “2” are provided to 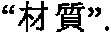
There exist seven dependency relationships under the branch menu “0”, and one dependency relationship under the branch menu “1”, and six dependency relationships under the branch menu “2”. Therefore, the tree tables <tree_tbl>[0] to <tree_tbl>[6] are assigned to the branch menu table <menu_tbl>[0] belonging to the GUI table <guitbl>[3], the tree table <tree_tbl>[0] is assigned to the branch menu table <menu_tbl>[1] belonging to the GUI table <guitbl>[3], and the tree tables <tree_tbl>[0] to <tree_tbl>[5] are assigned to the branch menu table <menu_tbl>[2] belonging to the GUI table <guitbl>[3].

The branch menus “0” and “1” are provided to 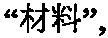
and there exist two each dependency relationships under these branch menus “0” and “1”. Accordingly, the tree tables <tree_tbl>[0] to <tree_tbl>[1] are assigned to the branch menu table <menu_tbl>[0] belonging to the GUI table <guitbl>[4], and the tree tables <tree_tbl>[0] to <tree_tbl>[1] are assigned to the branch menu table <menu_tbl>[1] belonging to the GUI table <guitbl>[4].

The branch menus “0” and “1” are also provided to 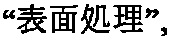
and there exist two each dependency relationships under the branch menus “0” and “1”. Thus, the tree tables <tree_tbl>[0] to <tree_tbl>[1] are assigned to the branch menu table <menu_tbl>[0] belonging to the GUI table <guitbl>[5], and the tree tables <tree_tbl>[0] to <tree_tbl>[1] are assigned to the branch menu table <menu_tbl>[1] belonging to the GUI table <guitbl>[5].

The LAN table <lantable>[0] includes *LAN_GUI_TABLE and LAN_GUI_MAXNUM. Described in four bytes forming *LAN_GUI_TABLE are first addresses of the GUI tables <guitbl>[0] to <guitbl>[N-1]. Described in one byte forming LAN_GUI_MAXNUM is a specific numerical value for “N” (=6).

Each of the GUI tables <guitbl>[0] to <guitbl>[N-1] includes *GUI_TABLE, GUI_SIZE, GUI_VISIBLE, GUI_SELECT, GUI_PROPERTY, *GUI_LINKADR, GUI_MAXNUM and GUI_MEMBER. Described in four bytes forming *GUI_TABLE is a first address of a desired character string contained in the character string data GUICONF0.DAT. The desired character string refers to 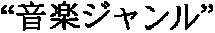
for the GUI table <guitbl>[0], 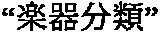
for the GUI table <guitbl>[1], and 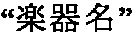
for the GUI table <guitbl>[2]. Also, the desired character refers to 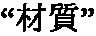
for the GUI table <guitbl>[3], 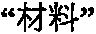
for the GUI table <guitbl>[4], and 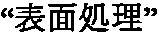
for the GUI table <guitbl>[5].

Described in one byte forming GUI_SIZE is a size of a character string to be displayed. For example, the size for 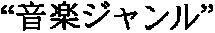
is 12 bytes and the size for 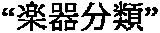
is 8 bytes.

Described in one byte forming GUI_VISIBLE is an identifier for showing the possibility of display. In this embodiment, all character strings can be displayed and thus an identifier indicative of “displayable” is always described in GUI_VISIBLE.

Described in one byte forming GUI_SELECT is an identifier for showing the possibility of selection. Due to the above described dependency relationships, there exist large items permitted to be selected and large items prohibited to be selected. Therefore, when the large item menu shown in FIG. 7 (A) is displayed, an identifier indicative of “selectable” is described in GUI_SELECT of the GUI tables <guitbl>[0] to <guitbl>[1], and an identifier indicative of “not selectable” is described in GUI_SELECT of the GUI tables <guitbl>[3] to <guitbl>[5].

Described in one byte forming GUI_PROPERTY is an identifier for showing a selection state of a small item belonging to the GUI table itself. An identifier indicative of “item unselected” is described if no small item belonging to the GUI table itself is yet selected, and an identifier indicative of “item selected” is described if any small item belonging to the GUI table itself is already selected. An identifier indicative of “item locked” is described if any small item belonging to the GUI table itself is locked in an unchangeable manner.

Described in four bytes forming *GUI_LINKADR are first addresses of the branch menu tables <menu_tbl>[0] to <menu_tbl>[I-1] belonging to the GUI table itself. Additionally, described in one byte forming GUI_MAXNUM is a specific numerical value for “I” (“5” for <guitbl>[2]).

Described in three bytes forming GUI_MEMBER is selection item information. More specifically, if a small item belonging to the GUI table itself is already selected or locked, the number for the branch menu to which this small item belongs is described in the 1st byte and the number for the small item itself is described in the 2nd byte. If no small item belonging to the GUI table itself is selected, “−1” is described in the 1st byte and the 2nd byte. Incidentally, the 0th byte is a reserved area.

Each of the branch menu tables <menu_tbl>[0] to <menu_tbl>[I-1] includes *str_table, str_maxnum, tree_maxnum and *tree_table. Described in four bytes forming *str_table are the first addresses of the menu strings <menu_str>[0] to <menu_str>[K-1] belonging to the branch menu table itself. Described in one byte forming str_maxnum is a specific numerical value for “K” (“4” for <menu_tbl>[0] belonging to <guitbl>[2]). Described in four bytes forming *tree_table are the first addresses of the tree tables <tree_tbl>[0] to <tree_tbl>[L-1] belonging to the branch menu table itself. Described in one byte forming tree_maxnum is a specific numerical value for “L” (“6” for <menu_tbl>[2] belonging to <guitbl>[3]).

Each of the menu strings <menu_str>[0] to <menu_str>[K-1] includes *m_string, m_length, and m_free. Described in four bytes forming *m_string is a first address of a desired character string contained in the character string data GUICONF0.DAT. Taking note of the menu strings <menu_str>[0] to <menu_str>[K-1] under the branch menu table <menu_tbl>[0] belonging to the GUI table <guitbl>[0], the desired character string refers to 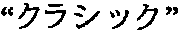
for the menu string <menu_str>[0], 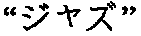
for the menu string <menu_str>[1], and 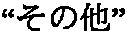
for the menu string <menu_str>[2].

Described in one byte forming m_length is the size of the desired character string. Described in one byte forming m_free is an identifier for showing the possibility of display. In this embodiment, the character strings represented by *m_string, i.e., small items are all displayed. Consequently, the identifier indicative of “displayable” is always described in m_free.

Each of the tree tables <tree_tbl>[0] to <tree_tbl>[11] includes gui_tree. Described in three bytes forming gui_tree is dependency relationship information. More specifically, the 0th byte is descriptive of the number for a dependent large item, the 1st byte is descriptive of the number for a dependent branch menu, and the 2nd byte is descriptive of the number for a dependent small item. For example, taking note of the tree table <tree_tbl>[0] under the branch menu table <menu_tbl>[2] belonging to the GUI table <guitbl>[2], the 0th byte, the 1st byte and 2nd byte of gui_tree are descriptive of “1”, “0” and “2”, respectively.

Referring to FIG. 17, the character string data GUICONF0.DAT includes data of character strings to be displayed on the menu screen. One character (double-byte character) forming each character string is described using two bytes. In addition, each of the character strings is separated by one byte descriptive of a null code. For example, 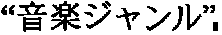
is described using 12 bytes, 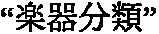
is described using 8 bytes, and a null code is described between

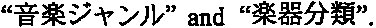

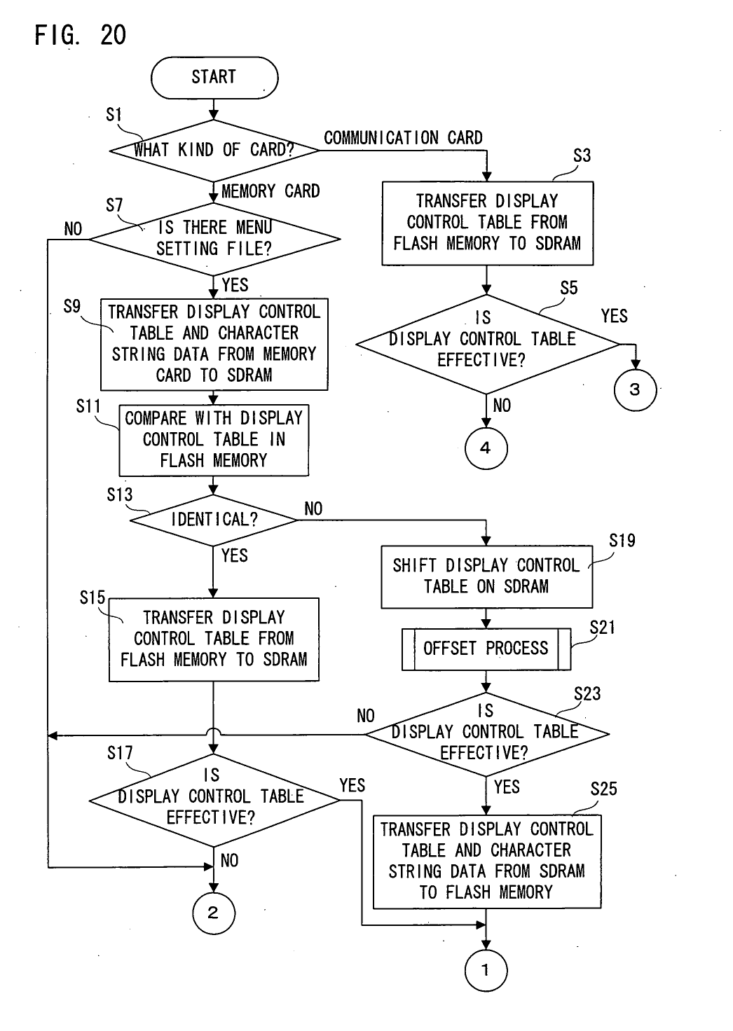

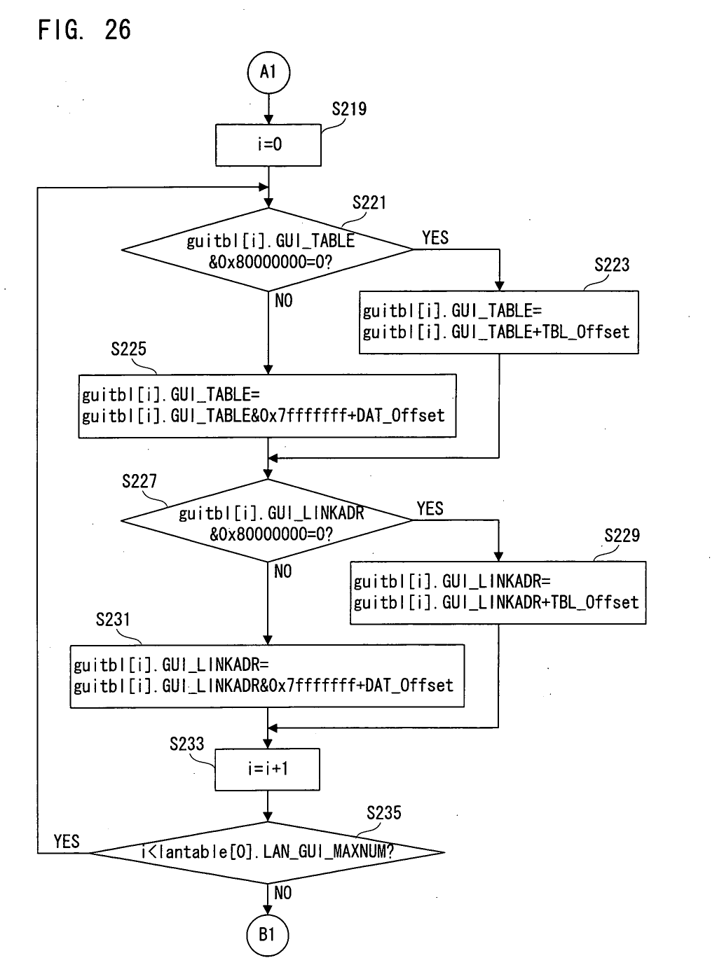

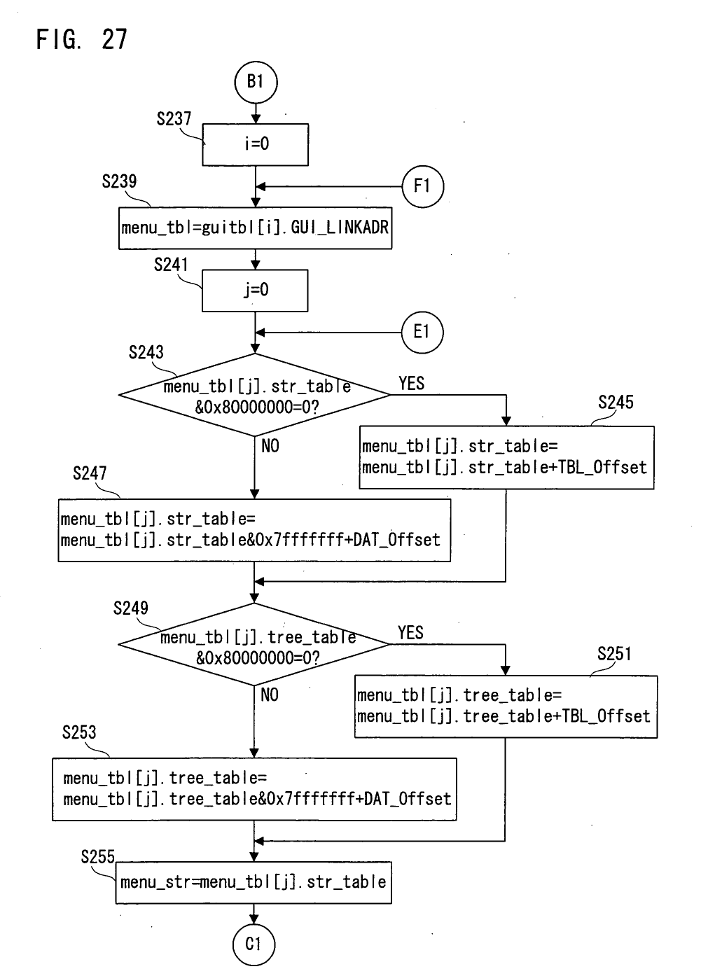

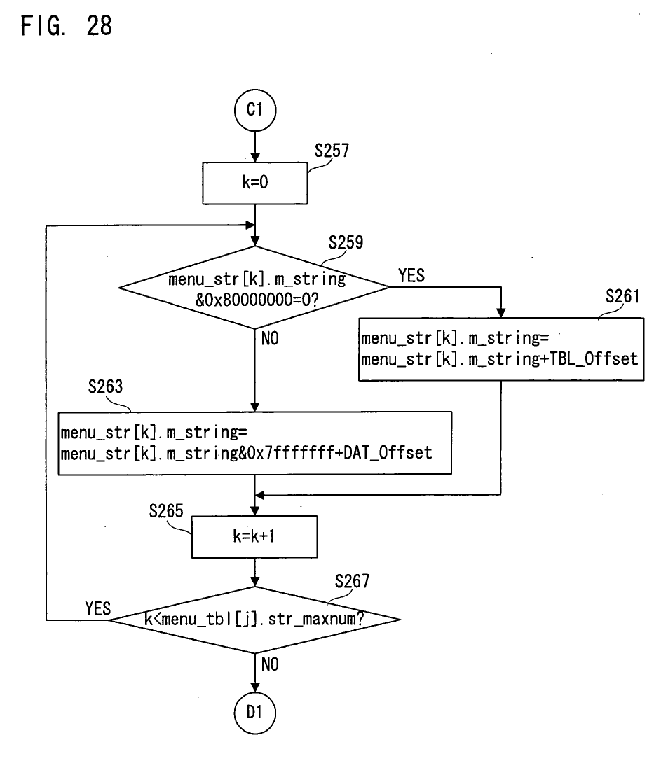

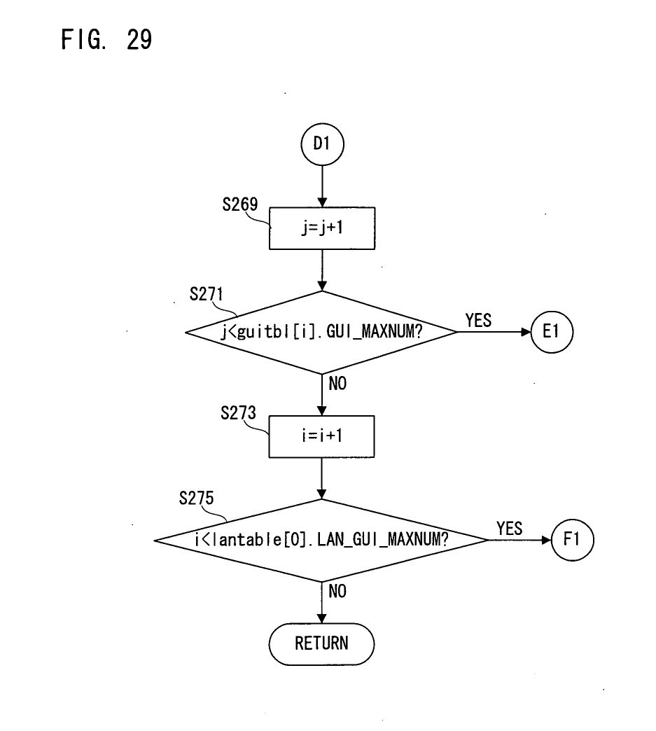

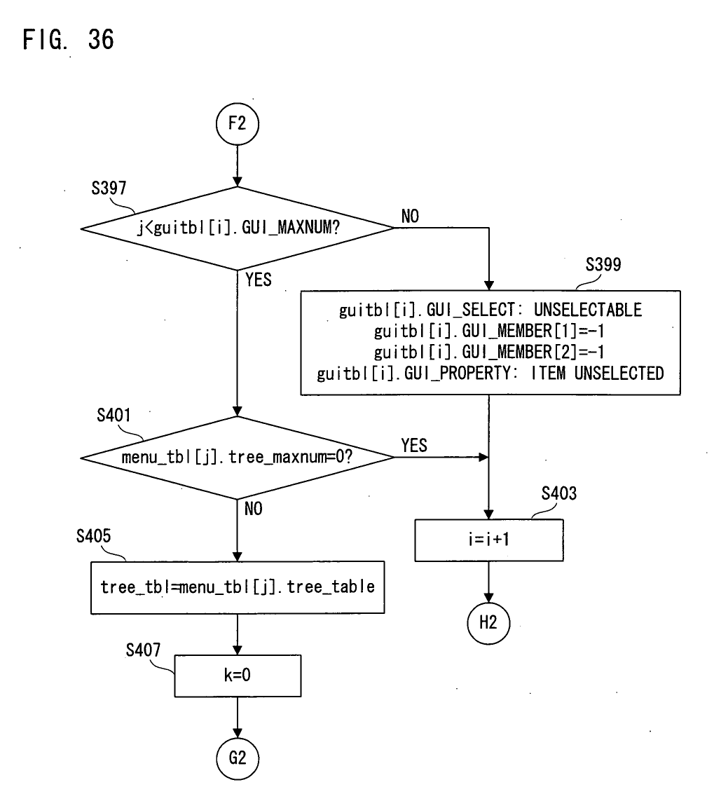

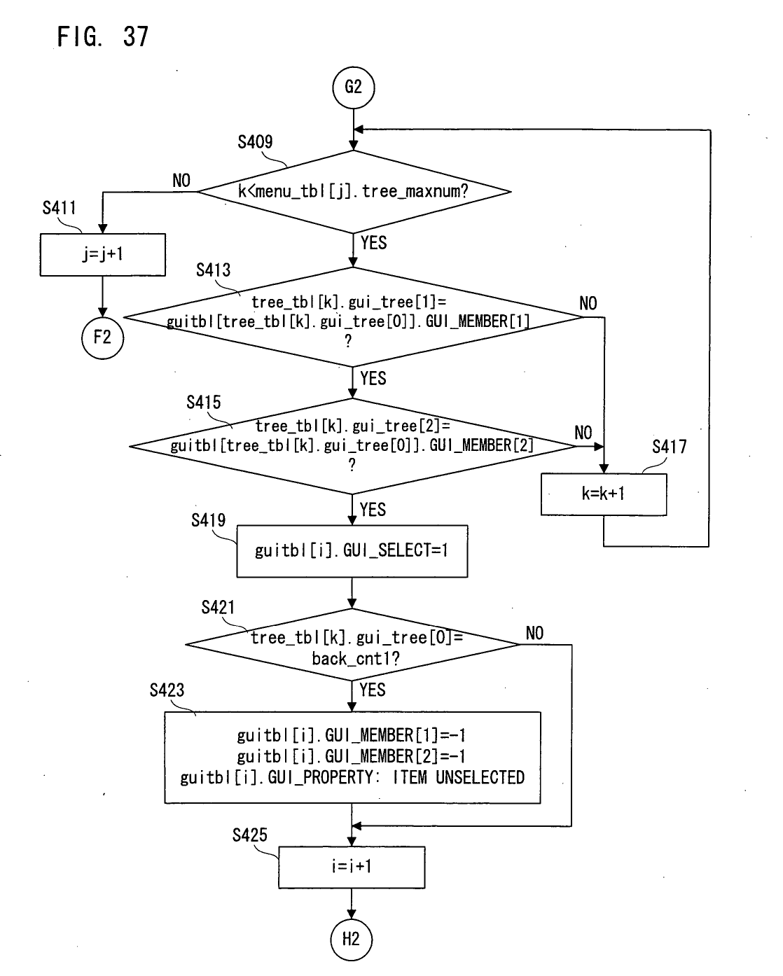

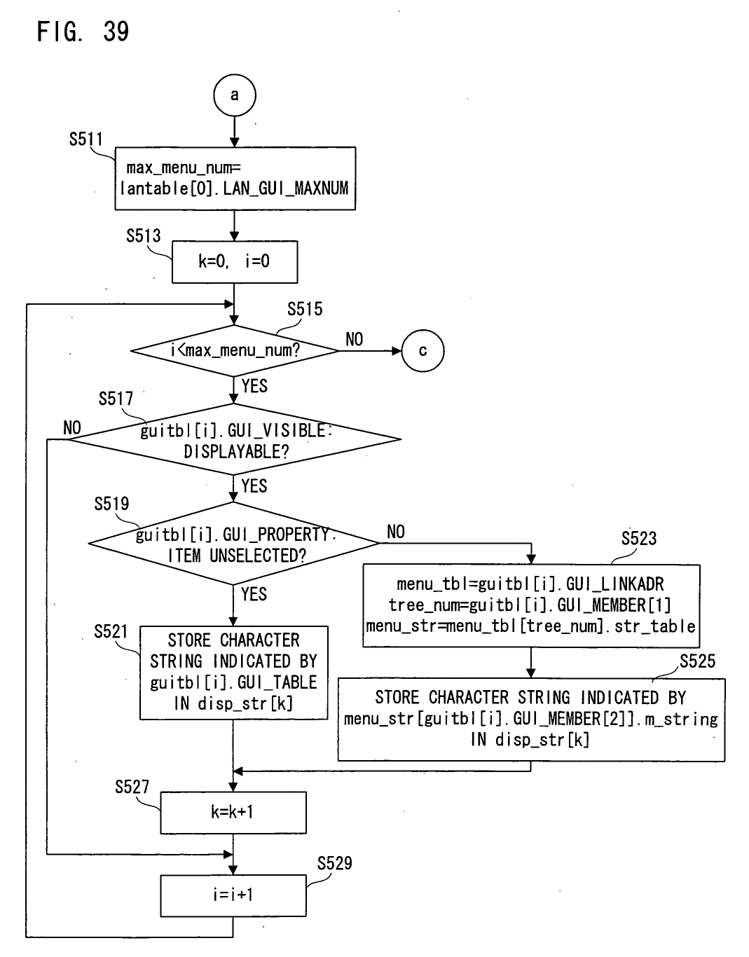

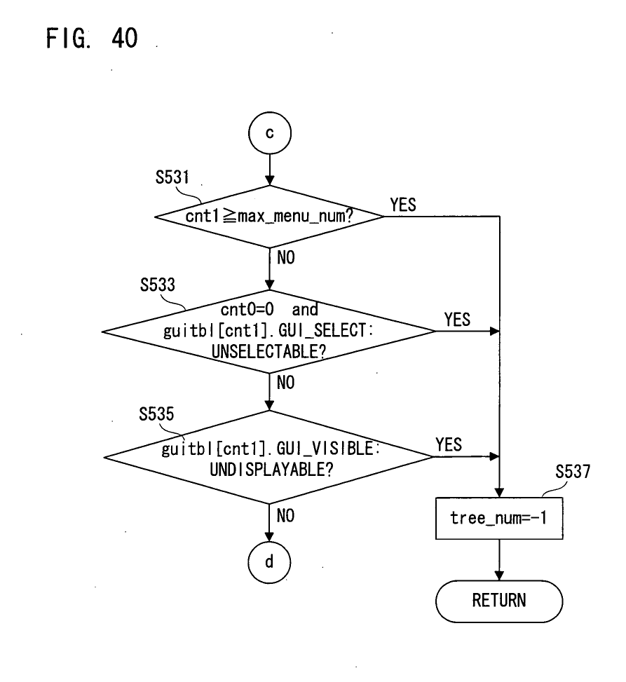

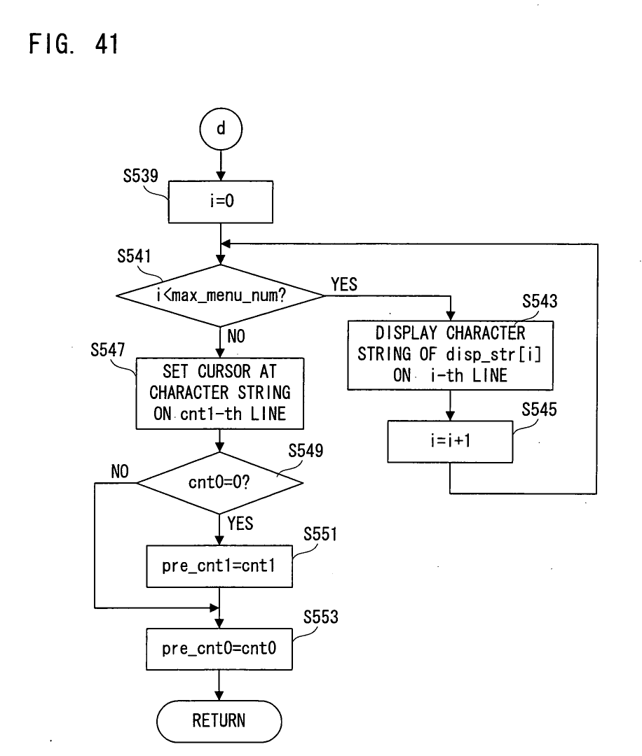

Next, an operation of the CPU 44 will be described below in detail with emphasis on a process of retaining menu file data in the SDRAM 22 and menu processes based on the display control table GUICONF0.TBL and the character string data GUICONF0.DAT. The CPU 44 executes a control program stored in the flash memory 42 and corresponding to flowcharts shown in FIG. 20 to FIG. 42.

Firstly, it is determined in a step S1 shown in FIG. 20 whether a card attached to the slot 36 is the memory card 38 or the communication card 40. If the attached card is the memory card 38, the process moves to a step S7 to determines whether or not a menu setting file is recorded on the memory card 38. If “NO” is determined, the process goes to a step S27. If “ES” is determined, the process proceeds to a step S9.

In a step S9, the display control table GUICONF0.TBL and the character string data GUICONF0.DAT which are stored in the menu setting file are transferred from the memory card 38 to the SDRAM 22. By this transfer process, size data of the display control table GUICONF0.TBL is written into four bytes starting with an address 0x49000000 of the SDRAM 22 shown in FIG. 18, and the display control table GUICONF0.TBL is written subsequently to these four bytes. In this embodiment, the display control table GUICONF0.TBL has a size of 0x34C bytes, and the end of the display control table GUICONF0.TBL is written at an address 0x4900034F. Size data of the character string data is written into four bytes starting with an address 0x49000350, and the character string data GUICONF0.DAT is written subsequently to these four bytes. The character string data GUICONF0.DAT has a size of 0x1E9 bytes, and the end of the character string data GUICONF0.DAT is written at an address 0x4900053D.

In a step S11, the display control table GUICONF0.TBL transferred to the SDRAM 22 is compared with the display control table GUICONF0.TBL stored in the flash memory 42. In a step S13, it is determined whether or not the two tables are identical with each other. If the two are identical, or if there exists no display control table GUICONF0.TBL in the flash memory 42, NO is determined in the step S13 and the display control table GUICONF0.TBL and its size data are moved on the SDRAM 22 in a step S19. More specifically, they are copied to an address 0x49000540 or later shown in FIG. 18.

In a step S21, the address value of the display control table GUICONF0.TBL is corrected by an offset operation. In a step S23, it is determined whether the corrected display control table GUICONF0.TBL is effective or not. If NO is determined here, the process moves to a step S27. If YES is determined, the process proceeds to a step S25. In the step S25, the original display control table GUICONF0.TBL and the character string data GUICONF0.DAT stored in the SDRAM 22 and the corrected display control table GUICONF0.TBL are transferred together with their size data to the flash memory 42. The original display control table GUICONF0.TBL, the character string data GUICONF0.DAT, the corrected display control table GUICONF0.TBL, and their size data are stored in the flash memory 42 in such a manner as shown in FIG. 19. Upon completion of the process of step S25, the process goes to a step S47.

If YES is determined in the step S13, the process moves to a step S15 to transfer the corrected display control table GUICONF0.TBL and its size data from the flash memory 42 to the SDRAM 22. The corrected display control table GUICONF0.TBL and its size data are written at an address 0x49000540 or later shown in FIG. 18. In a step S17, the same determination process as the step S23 is carried out. If NO is determined, the process moves to the step S27. If YES is determined, the process moves to the step S47.

When the communication card 40 is attached to the slot 36, the same processes as the steps S15 and S17 are performed in steps S3 and S5. Then, if NO is determined in the step S5, the process goes to a step S67. If YES is determined in the step S5, the process goes to a step S97.

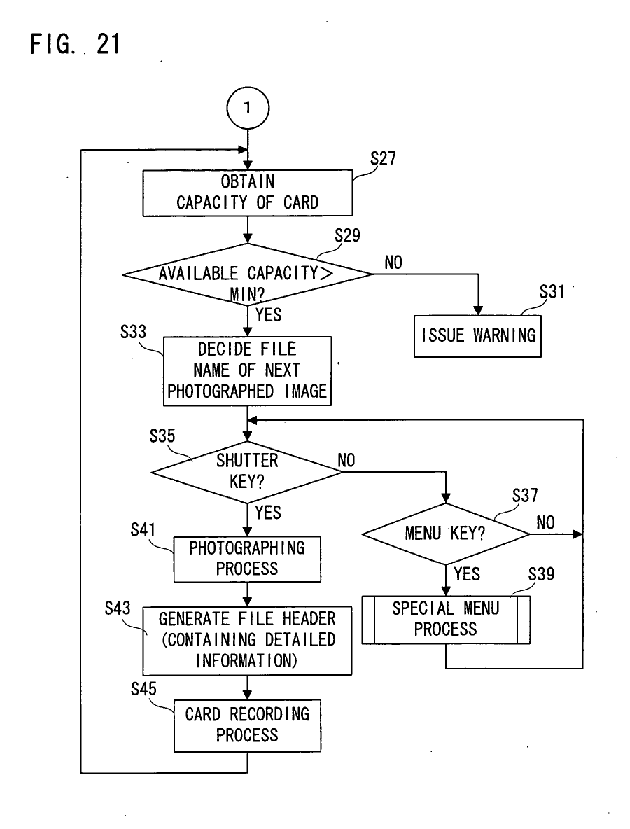

In the step S27 shown in FIG. 21, available capacity of the memory card 38 is obtained. In a succeeding step S29, the obtained available capacity is compared with a threshold value MIN. If the available capacity is equal to or less than the threshold value MIN, NO is determined in the step S29 and a warning is issued in a step S31. On the other hand, if the available capacity exceeds the threshold value MIN, the process moves from the step S29 to a step S33 to decide a file name of an image file storing JPEG data to be obtained by next photographing.

In a step S35, the presence or absence of an operation of the shutter key 46 is determined. In a step S37, the presence or absence of an operation of the menu key 48 is determined. When the menu key 48 has been operated, a special menu process is performed in a step S39. Upon completion of the process, the process returns to the step S39. By the special menu process, detailed information is generated in such a manner as shown in FIG. 7 (A) to FIG. 14 (B). When the shutter key 46 has been operated, a photographing process is performed in a step S41 and a file header is created in a step S43. By the photographing process in the step S41, JPEG data of a photographed image is obtained. Also, by the process of step S43, the detailed information generated by the special menu process is embedded in the file header. In a step S45, the image file containing the JPEG data and the file header is recorded on the memory card 38. Upon completion of the process of step S45, the process returns to the step S27.

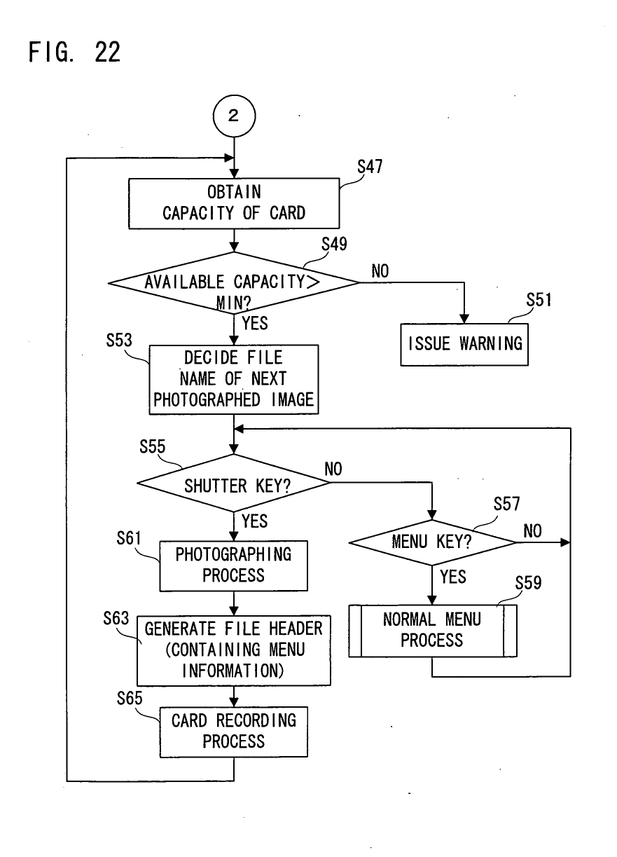

The processes of steps S47 to S65 shown in FIG. 22 are the same as the above described ones in the steps S27 to S45, except that a normal menu process is performed in the step S59 and that a file header containing menu information generated by the normal menu process is created in the step S63. Thus, a duplicate description is omitted.

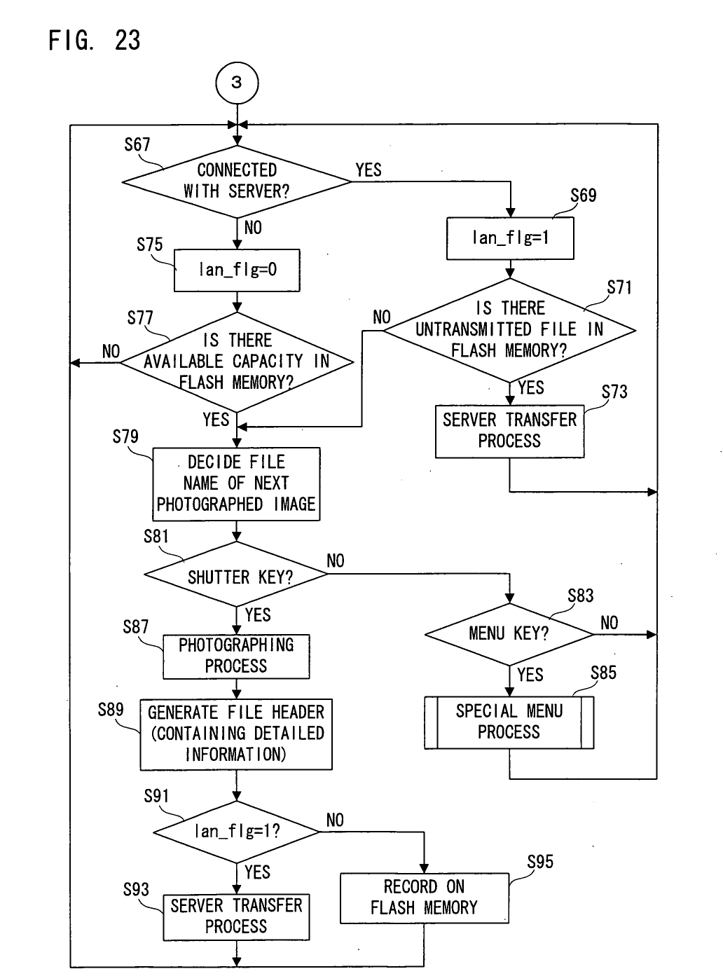

In a step S67 shown in FIG. 23, it is determined whether or not connection with the server is established. If NO is determined here, a flag lan_flg is reset in a step S75, and it is determined in a step S77 whether or not there is sufficient available capacity in the flash memory 42. If the available capacity is sufficient, the process moves from the step S77 to a step S79. If the available capacity is not sufficient, the process returns from the step S75 to the step S67.

If YES is determined in the step S67, the flag lan_flg is set in a step S69, and it is determined in a step S71 whether or not there exists any untransmitted image file in the flash memory 42. If NO is determined, the process goes to a step S79. If YES is determined, the process returns to the step S67 through a server transfer process in a step S73. By the server transfer process, the untransmitted image file is read out from the flash memory 42, and the read untransmitted image file is transferred to the server through the communication card 40.

In steps S79 to S89, the same processes as those in the above described steps S33 to S43 are carried out. Thus, desired detailed information is generated by operating the menu key 48, and an image file containing JPEG data and detailed information of the photographed image is created by operating the shutter key 46. In a step S91, the state of the flag lan_flg is determined. If the flag lan_flg is in a set state, the process goes to a step S93 to transfer the created image file to the server via the communication card 40. If the flag lan_flg is in a reset state, the process goes to a step S95 to record the created image file on the flash memory 42. Upon completion of the processes of steps S93 to S95, the process returns to the step S67.

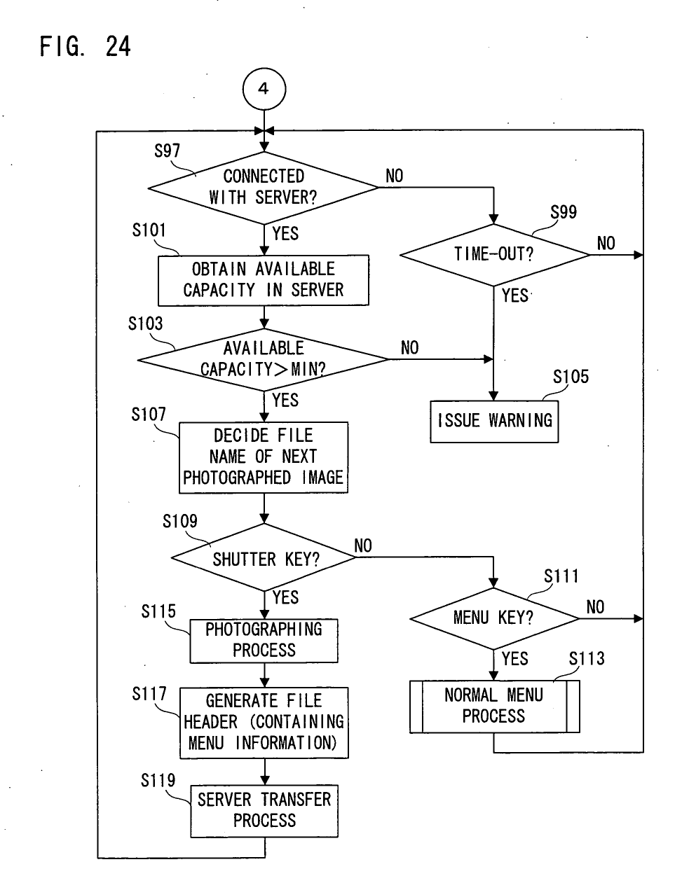

Referring to FIG. 24, it is determined in a step S97 whether or not connection with the server is established. If the connection is not established, the process moves to a step S99 to determine whether a timeout has occurred or not. Then, if no timeout has occurred, the process returns to the step S97. If a timeout has occurred, a warning is issued in a step S105.

If connection with the server is established, available capacity of the server is obtained in a step S101 and is compared with the threshold value MIN in a step S103. If the available capacity is equal to or less than the threshold value MIN, a warning is issued in a step S105. If the available capacity exceeds the threshold value MIN, the same processes as those in the above described S55 to S63 are performed in steps S107 to S117. Accordingly, desired menu information is generated by operating the menu key 48, and an image file containing JPEG data and menu information for a photographed image is created by the operating the shutter key 46. In a step S119, the same server transfer process as that in the step S93 is carried out. Upon completion of the process, the process returns to the step S97.

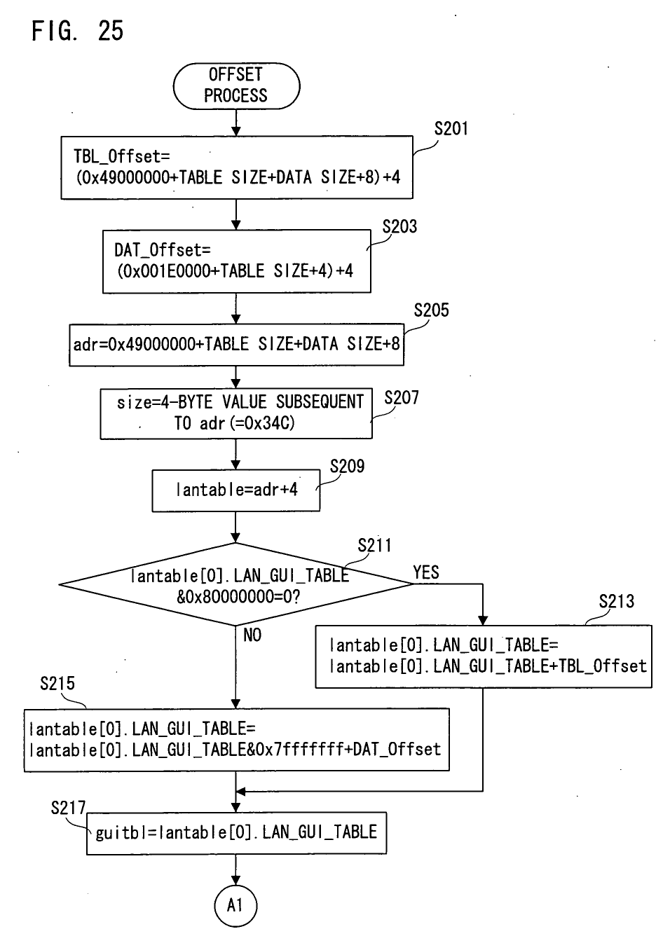

The offset process of step S21 shown in FIG. 20 complies with a subroutine shown in FIG. 25 to FIG. 29. Referring to FIG. 25, an offset value TBL_Offset is firstly calculated according to equation 1 in a step S201, an offset value DAT_Offset is calculated according to equation 2 in a step 203, and an address value adr is calculated according to equation 3 in a step S205.
TBL_{—}Offset=(0x49000000+display control table size+character string data size+8)+4 [Equation 1]
DAT_{—}Offset=(0x001E0000+display control table size+4)+4 [Equation 2]
adr=0x49000000+display control table size+character string data size+8 [Equation 3]

By the operation of equation 1, the address value 0x49000000 shown in FIG. 18, the size values of the original display control table GUICONF0.TBL and character string data GUICONF0.DAT, a size value for description of each size data (=8 bytes), and a size value for description of size data for the corrected display control table GUICONF0.TBL (=4 bytes) are added all together. The value TBL_Offset points to the first address of the corrected display control table GUICONF0.TBL.

By the operation of equation 2, an address value 0x001E0000 shown in FIG. 19, the size value of the original display control table GUICONF0.TBL, the size value for description of the size data (=4 bytes), and the size value for description of size data of the original character string GUICONF0.DAT (=4 bytes) are added all together. The value DAT_Offset points to the first address of the original character string data GUICONF0.DAT.

By the operation of equation 3, the address value 0x49000000 shown in FIG. 18, the size values of the original display control table GUICONF0.TBL and character string data GUICONF0.DAT, and the size value for description of each size data (=8 bytes) are added all together. The variable adr points to the first address of 4 bytes in which the data size of the corrected display control table GUICONF0.TBL is described.

In a step S207, a 4-byte value subsequent to the variable adr is set as a variable size. The variable size indicates the size of the corrected display control table GUICONF0.TBL. In a step S209, a value of the variable adr plus “4” is set as a variable lantable. As a result, a LAN table <lantable>[0] shown in FIG. 16 is noticed.

In a step S211, a most significant bit value of *LAN_GUI_TABLE contained in the LAN table <lantable>[0] is determined. If the most significant bit value is “0”, the process moves to a step S213. If the most significant bit value is “1”, the process goes to a step S215. In the step S213, the offset value TBL_Offset is added to the address value described in *LAN_GUI_TABLE, and the added value is described in *LAN_GUI_TABLE. In the step S215, a most significant address value described in *LAN_GUI_TABLE is changed to “0”, the offset value DAT_Offset is added to the changed address value, and the added value is described in *LAN_GUI_TABLE. In this embodiment, the most significant bit value of *LAN_GUI_TABLE is constantly “0”, and the process of step S213 is invariably carried out.

In a step S217, the address value updated in the step S213 or S215 is set as a variable guitbl. Thus, the GUI table <guitbl>[0] shown in FIG. 16 is noticed. In a step S219, the variable i is set to “0”. In a step S221, a most significant bit value of *GUI_TABLE contained in the GUI table <guitbl>[i] is determined.

If the most significant bit value is “0”, the process goes to a step S223. If the most significant bit value is “1”, the process goes to a step S225. In the step 223, the offset value TBL_Offset is added to the address value described in *GUI_TABLE, and the added value is described in *GUI_TABLE. In the step S225, the most significant bit value of the address value described in *GUI_TABLE is changed to “0”, and the offset value DAT_Offset is added to the changed address value, and the added value is described in *GUI_TABLE. In this embodiment, the most significant bit value of *GUI_TABLE is constantly “1”, and the process of step S225 is invariably carried out.

Upon completion of the process of step S223 or S225, the process moves to a step S227 to determine a most significant bit value of *GUI_LINKADR contained in the GUI table <guitbl>[i]. If the most significant bit value is “0”, the process goes to a step S229. If the most significant bit value is “1”, the process goes to a step S231. In the step 229, the offset value TBL_Offset is added to the address value described in *GUI_LINKADR, and the added value is described in *GUI_LINKDR. In the step S231, the most significant bit value of the address value described in *GUI_LINKADR is changed to “0”, the offset value DAT_Offset is added to the changed address value, and then the added value is described in *GUI_LINKADR. In this embodiment, the most significant bit value of *GUI_LINKADR is constantly “0”, and the process of step S229 is invariably carried out.

In a step S233, the variable i is incremented. In a step S235, the updated variable i is compared with a numerical value N indicated by *LAN_GUI_MAXNUM of the LAN table <lantable>[0]. Then, as far as the variable i is less than the numerical value N, the processes of steps S221 to S233 are repeatedly carried out. When the variable i has reached the numerical value N, the process moves from the step S235 to a step S237.

In a step S237, the variable i is set to “0” again. In a step S239, the address value (updated address value) indicated by *GUI_LINKADR contained in the GUI table <guitbl>[i] is set as a variable menu_tbl. In a step S241, a variable j is set to “0”. In a step S243, a most significant bit value of *str_table is determined with respect to the branch menu table <menu_tbl>[i] belonging to the GUI table <guitbl>[i]. If the variables i and j are both “0”, the most significant bit value of *str_table is determined with respect to the branch menu table <menu_tbl>[0] belonging to the GUI table <guitbl>[0].

If the most significant bit value is “0”, the process goes to a step S245. If the most significant bit value is “1”, the process moves to a step S247. In the step S245, the offset value TBL_Offset is added to the address value described in *str_table, and the added value is described in *str_table. In the step S247, the most significant bit value of the address value described in *str_table is changed to “0”, the offset value DAT_Offset is added to the changed address value, and then the added value is described in *str_table. In this embodiment, the most significant bit value of *str_table is constantly “0”, and the process of step S245 is invariably carried out.

In the step S249, a most significant bit value of *tree_table contained in the noticed branch menu table <menu_tbl>[j] is determined. If the most significant bit value is “0”, the process goes to a step S251. If the most significant bit value is “1”, the process moves to a step S253. In the step S251, the offset value TBL_Offset is added to the address value described in *tree_table, and the added value is described in *tree_table. In the step S253, the most significant bit value of the address value described in *tree_table is changed to “0”, the offset value DAT_Offset is added to the changed address value, and then the added value is described in *tree_table. In this embodiment, the most significant bit value of *tree_table is constantly “0”, and the process of step S251 is invariably carried out.

Upon completion of the process of step S251 or S253, the process moves to a step S255 to set the address value updated in the immediately preceding step S245 or S247 as a variable menu_str. Therefore, the menu strings <menu_str>[0] to <menu_str>[K-1] under the noticed branch menu table <menu_tbl>[j] is taken noted of.

In a step S257, a variable k is set to “0”. In a step S259, a most significant bit value of *m_string contained in the menu string <menu_str>[k] is determined. If the variable i, j and k are all “0”, the most significant bit value of *m_string is determined with respect to the menu string <menu_str>[0] under the branch menu table <menu_tbl>[0] belonging to the GUI table <guitbl>[0].

If the most significant bit value is “0”, the process moves to a step S261. If the most significant bit value is “1”, the process goes to a step S263. In the step S261, the offset value TBL_Offset is added to the address value described in *m_string, and the added value is described in *m_string. In the step S263, the most significant bit value of the address value described in *m_string is changed to “0”, the offset value DAT_Offset is added to the changed address value, and then the added value is described in *m_string. In this embodiment, the most significant bit value of *m_string is constantly “1”, and the process of step S263 is invariably carried out.

Upon completion of the process of step S261 or S263, the variable k is incremented in a step S265. In a step S267, the updated variable k is compared with a numerical value K indicated by str_maxnum of the branch menu table <menu_tbl>[j]. Then, as far as the variable k is less than the numerical value K, the processes of steps S259 to S265 are repeatedly carried out. When the variable k has reached the numerical value K, NO is determined in a step S267 and the variable j is incremented again in a step S269.

In a step S271, the updated variable j is compared with a numerical value I indicated by GUI_MAXNUM of the GUI table <guitbl>[j]. Then, as far as the variable j is less than the numerical value I, the processes of steps S243 to S269 are repeatedly carried out. When the variable j has reached the numerical value I, the variable i is incremented in a step S273 and the process goes to a step S275. In the step S275, the updated variable i is compared with the numerical value N indicated by *LAN_GUI_MAXNUM of the LAN table <lantable>[0]. Then, as far as the variable i is less than the numerical value N, the processes of steps S239 to S273 are repeatedly carried out. When the variable i has reached the numerical value N, the process returns to a hierarchical upper routine.

By this offset process, established are a link in the display control table GUICONF0.TBL copied subsequently to an address 0x49000540 shown in FIG. 18 and a link between the display control table GUICONF0.TBL and the character string data GUICONF0.TBL shown in FIG. 19.

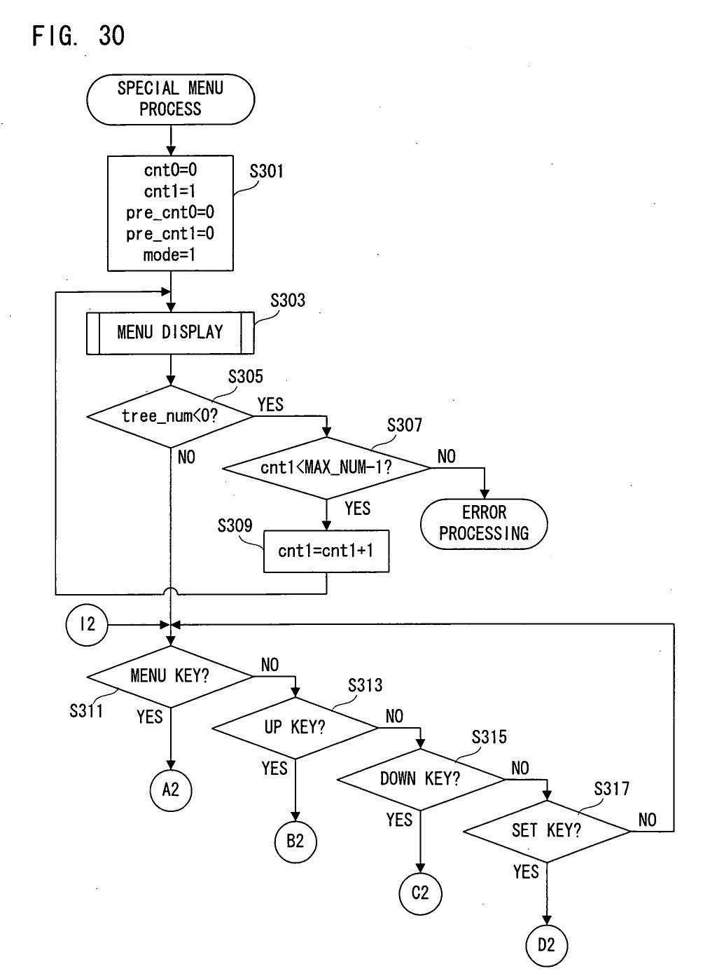

The special menu process of the step S39 shown in FIG. 21 or step S85 shown in FIG. 23 complies to the subroutine described in FIG. 30 to FIG. 42.

Firstly, all kinds of variables are initialized in a step S301 shown in FIG. 30. More specifically, a variable cnt0 is set to “0”, a variable cnt1 is set to “1”, a variable pre_cnt0 is set to “0”, a variable pre_cnt1 is set to “0”, and a variable mode is set to “1”. The variable cnt0 here is a variable for identifying which to be displayed on the screen, a large item menu or a branch menu. The equation cnt0=0 means display of a large item menu, and the equation cnt0=1 means display of a branch menu. The variable cnt1 is a variable for identifying a display position of the cursor CS. With an increasing value of the variable cnt1, the display position of the cursor CS shits downward. The variables pre_cnt0 and pre_cnt1 are the previous values of the variables cnt0 and cnt1, respectively. The variable mode is a variable for identifying rendering/clearing of a menu screen. The equation mode=1 means rendering of a menu screen, and the equation mode=−1 means clearing of a menu screen.

In a step S303, a menu display process is carried out. This allows a large item menu shown in FIG. 7 (A) to be displayed on the screen. Upon completion of menu display, a value of a variable tree_num is determined in a step S305. The variable tree_num is a variable indicative of the number for an item pointed by the cursor CS. However, if an error occurs during the menu display process, the variable tree_num indicates “−1”.

When the variable tree_num is “−1”, the process moves from the step S305 to a step S307 to compare the variable cnt1 with a threshold value MAX_NUM−1. The value MAX_NUM is an upper limit of the number of displayable items. If the variable cnt1 is below the threshold value MAX_NUM−1, the variable cnt1 is incremented in a step S309 and then the process returns to the step S303. When the variable cnt1 has reached the threshold value MAX_NUM-1, NO is determined in the step S307 and error processing is carried out.

The variable tree_num is not “−1”, YES is determined in the step S305 and a key operation is determined in steps S311 to S317. More specifically, the presence or absence of operation of the menu key 48 is determined in the step S311, the presence or absence of operation of the up key 52 is determined in the step S313, the presence or absence of operation of the down key 54 is determined in a step S315, and the presence or absence of operation of the set key 50 is determined in the step S317.

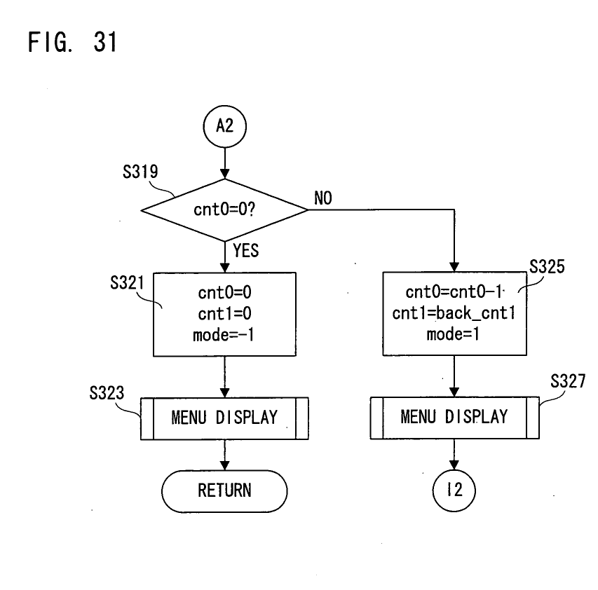

If the menu key 48 is operated, the process moves from the step S311 to a step S319 shown in FIG. 31 to determine the value of the variable cnt0. If the variable cnt0 is “0”, that is, if the large item menu is displayed on the screen, processes of a step S321 and later are performed to clear the menu screen. In the step S321, the variables cnt0, cnt1 and mode are set to “0”, “0” and “−1”, respectively. In a step S323, a menu display process is carried out. When clearing of the menu screen has been completed by the menu display process, the process returns to a hierarchical upper routine.

On the contrary, if the variable cnt0 is “1”, that is, if a branch menu is displayed on the screen, processes of a step S325 and later are performed to return from the branch menu to the large item menu. In the step S325, the variable cnt0 is returned to “0”, the variable cnt1 is set to a variable back_cnt1, and the variable mode is set to “1”. The variable back_cnt1 is a variable for temporarily saving the value of the variable cnt1 at a time of transition from the large item menu to the branch menu. By the process of step S325, the saved value is returned to the variable cnt1. In a step S327, a menu display process is performed and thus the large item menu is displayed on the screen. Upon completion of the process of step S327, the process returns to the step S311.

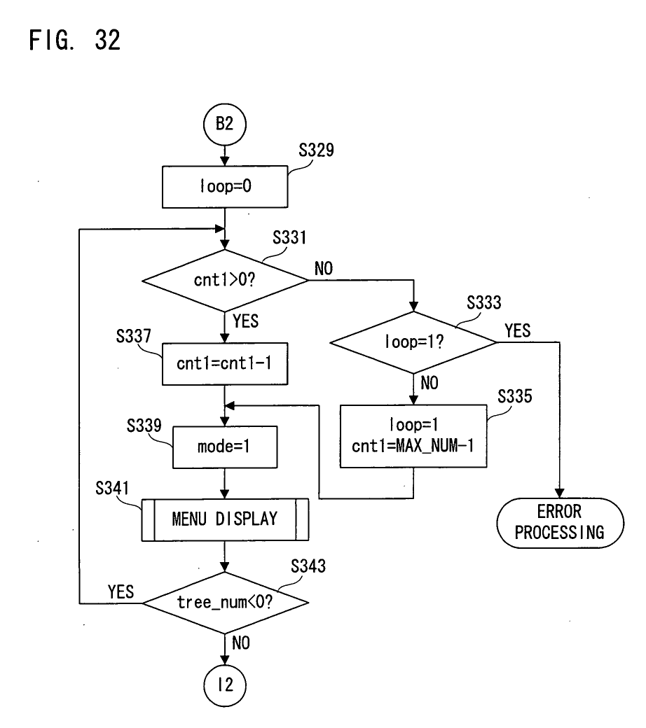

If the up key 52 is operated, the process moves from the step S313 shown in FIG. 30 to a step S329 shown in FIG. 32 to set a variable loop to “0”. The variable loop is a variable for indicating whether to shift the display position of the cursor CS in a ring-formed manner. The value “0” indicates that no ring-formed shift is required, and the value “1” indicates that a ring-formed shift is necessary. In the step S331, the value of the variable cnt1 is determined if the variable cnt1 is larger than “0”, it is concluded that the cursor CS can be moved upward, and the variable cnt1 is decremented in a step S337. In a step S339, the variable mode is set to “1”. In a step S341, a menu display process is performed to move the cursor CS upward. In a step S343, the value of the variable tree_num is determined. If the variable tree_num is “−1”, it is concluded that an error has occurred in the menu display process, and the process returns to the step S331. If the variable tree_num is “0” or larger, it is concluded that the menu display process has been properly performed, and the process returns to the step S311.

If NO is determined in the step S331, the value of the variable loop is determined in a step S333. Then, if the variable loop is “1”, error processing is carried out. If the variable loop is “0”, the variable loop is updated to “1” and the variable cnt1 is set to the threshold value MAX_NUM-1 in a step S335. Upon completion of the process of step S335, the process goes to a step S341 to perform a menu display process in order to move the cursor CS to a lowest section of the screen.

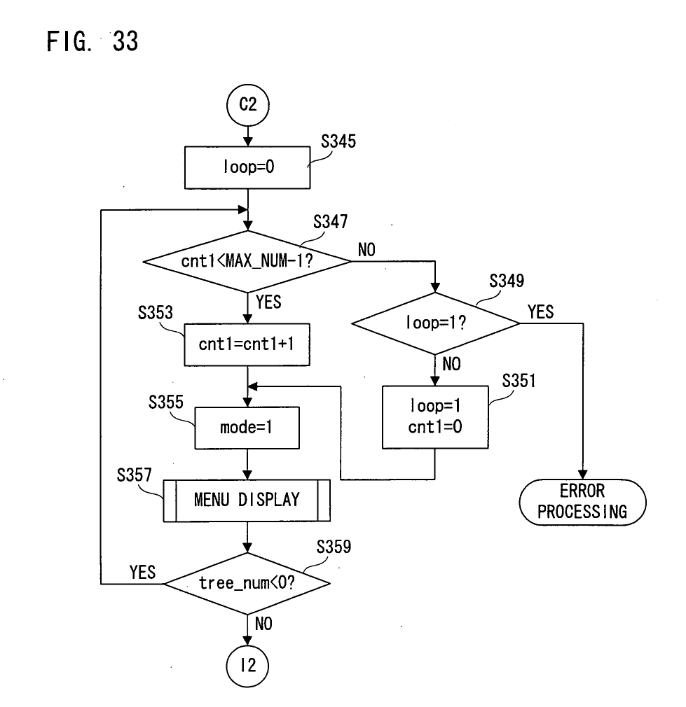

If the down key 54 is operated, YES is determined in the step S315 shown in FIG. 30 and processes of steps S345 to S359 shown in FIG. 33 are carried out. However, this series of processes is the same as the above described steps S329 to S343, except that the variable cnt1 is compared with the threshold value MAX_NUM−1 in the step S347, the variable cnt1 is incremented in the step S353, and the variable cnt1 is set to “0” in the step S351. Therefore, a duplicate description is omitted.

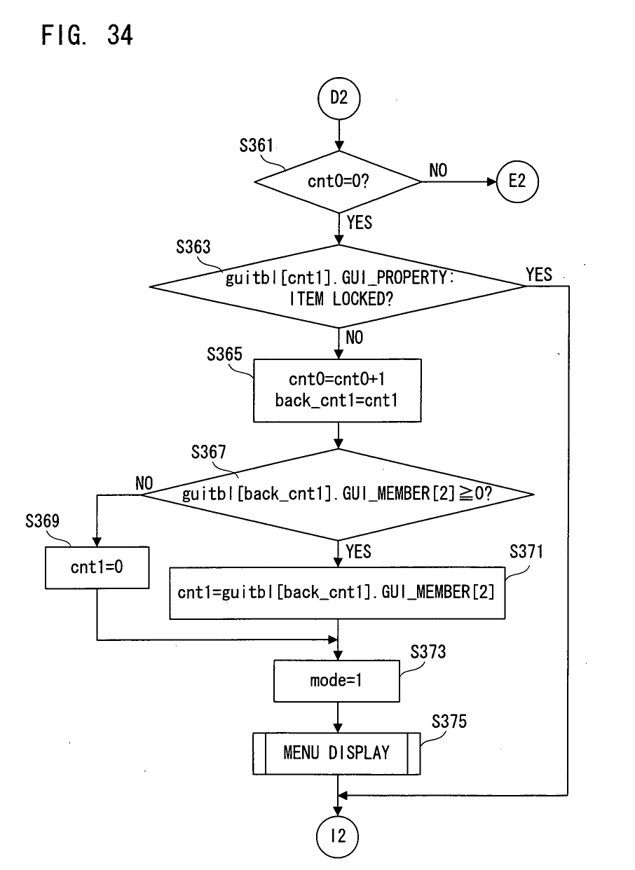

If the set key 50 is operated, YES is determined in the step S317 shown in FIG. 30, and the process moves to a step S361 shown in FIG. 34. In the step S361, it is determined which is displayed on the screen, a large item menu or a branch menu, on the basis of the variable cnt0. If the variable cnt1 is “0”, it is concluded that the large item menu is displayed, and a process of updating the large item menu to the branch menu is carried out in a step S363 and later.

In the step S363, firstly, an identifier for GUI_PROPERTY contained in the GUI table <guitbl>[cnt1] is determined. If this identifier indicates “item locked”, the process returns directly to the step S311. As a result, this operation of the set key 50 is regarded as invalid and the large item menu is continuously displayed. If the identifier indicates “item unselected” or “item selected”, the process moves to a step S365 to set the variable cnt0 to “1” indicative of display of the branch menu, and the value of the variable cnt1 is saved to the variable back_cnt1.

In a step S367, referring to a 2nd byte value of GUI_MEMBER contained in the GUI table <guitbl>[back_cnt1], it is determined whether or not there exists an already selected small item in the branch menu to be displayed from now. If this 2nd byte value is “0” or larger, it is concluded that there exists a selected small item, and the 2nd byte value is set to the variable cnt1 in a step S371. On the contrary, if the 2nd byte value is “−1”, it is concluded that there is no selected small item, and the variable cnt1 is set to “0” in the step S369. In a step S373, the variable mode is set to “1”. In a step S375, a menu display process is carried out.

Accordingly, if the set key 50 is operated in a state where the cursor CS is pointed to 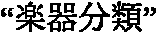
as shown in FIG. 7 (B), screen display is shifted to that shown in FIG. 8 (B). That is, since none of the small items belonging to 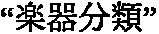
is selected, the cursor CS is pointed to the first item 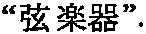
In contrast, if the set key 50 is operated in a state where the cursor CS is pointed to 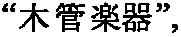
screen display is shifted to that shown in FIG. 8 (B). That is, since the small item 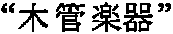
belonging to 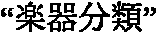
is already selected, the cursor CS is pointed to 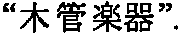
Upon completion of the process of step S375, the process returns to the step S311.

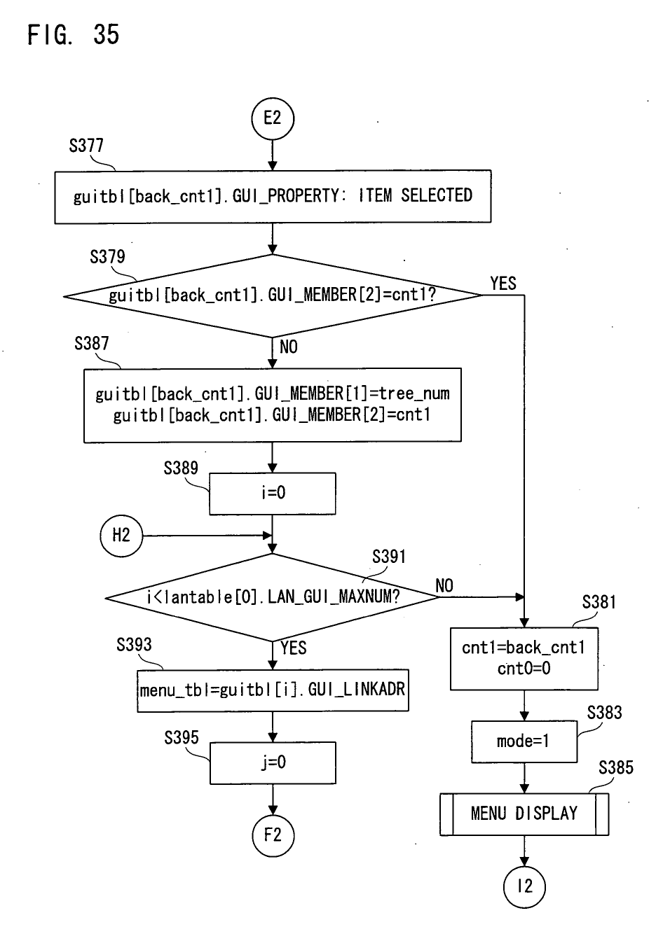

If NO is determined in the step S361, it is concluded that the branch menu is displayed on the screen, and a process of returning to the large item menu is carried out in a step S377 shown in FIG. 35 and later. In the step S377, firstly, the identifier indicative of “item selected” is described in GUI_PROPERTY contained in the GUI table <guitbl>[back_cnt1]. In a succeeding step S379, it is determined whether or not the 2nd byte value of GUI_MEMBER contained in the GUI table <guitbl>[back_cnt1] is equal to the variable cnt1.

If the 2nd byte value of GUI_MEMBER and the variable cnt1 are coincident with each other, it is concluded that the selected small item is selected again, and the process moves from the step S379 to a step S381. In the step S381, the variable back_cnt1 is set to the variable cnt1, and the variable cnt0 is set to “0”. In a step S383, the variable mode is set to “1”. Upon completion of the process of step S383, a menu display process is carried out in a step S385.

For example, if a transition is made from the large item menu shown in FIG. 9 (A) to the branch menu shown in FIG. 8 (B) and 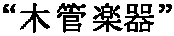
is selected again, the 2nd byte value of GUI_MEMBER is coincident with the variable cnt1. At this time, the processes from steps S381 to S385 are carried out. The screen display returns from the branch menu shown in FIG. 8 (B) to the large item menu shown in FIG. 9 (A).

If the 2nd byte value of GUI_MEMBER and the variable cnt1 are not coincident with each other, it is concluded that an unselected small item is selected, and the process moves from the step S379 to a step S387. In the step S387, the variables tree_num and cnt1 are set to the 1st byte and 2nd byte of GUI_MEMBER contained in the GUI table <guitbl>[back_cnt1], respectively. For example, if a transition is made from the large item menu shown in FIG. 9 (A) to the branch menu shown in FIG. 9 (B) and 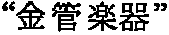
is selected, the branch menu number “0” and the small item number “2” are described in the 1st byte and 2nd byte of GUI_MEMBER contained in the GUI table <guitbl>[1].

However, by selecting an unselected small item, the number of items to be displayed on the large item menu may be changed. For instance, if a transition is made from the large item menu shown in FIG. 9 (B) to the branch menu shown in FIG. 10 (A) and 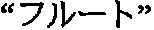
is selected, the number of items in the large item menu is increased as shown in FIG. 11 (A). Also, a transition is made from the large item menu shown in FIG. 11 (A) to the branch menu shown in FIG. 8 (B) and 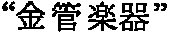
is selected, the number of the items in the large item menu is decreased as shown in FIG. 9 (A) (however, 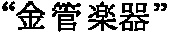
is displayed in place of 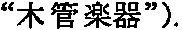
On this account, a process of verifying a dependency relationship is carried out in a step S391 and later.

Firstly, the variable i is set to “0” in the step S389, and the variable i is compared with the numerical value N indicated by LAN_GUI_MAXNUM contained in the LAN table <lantable>[0] in the step S391. Then, processes of steps S393 to S425 are repeatedly performed as far as the variable i is below the numerical value N. When the variable i has reached the numerical value N, the process goes to the step S381.

In the step S393, the address value described in *GUI_LINKADR of the GUI table <guitbl>[i] is set as the variable menu_tbl. Therefore, the menu tables <menu_tbl>[0] to <menu_tbl>[K-1] belonging to the GUI table <guitbl>[i] are taken note of.

In the step S395, the variable j is set to “0”. In the step S397, the variable j is compared with the numerical value I indicated by GUI_MAXNUM contained in the GUI table <guitbl>[i]. Then, in the step S401, the numerical value L indicated by tree_maxnum contained in the menu table <menu_tbl>[j] is determined.

If the variable j is equal to or larger than the numerical value I, the process moves from the step S397 to the step S399. In the step S399, an identifier indicative of “unselectable” is described in GUI_SELECT contained in the GUI table <guitbl>[i], the identifier indicative of “item unselected” is described in GUI_PROPERTY contained in the GUI table <guitbl>[i], and “−1” is described in the 1st byte and 2nd byte of GUI_MEMBER contained in the GUI table <guitbl>[i]. Upon completion of the process of step S399, the variable i is incremented in a step S403, and the process returns to the step S391. Incidentally, the process of step S399 will be described together with the process of step S423 as referred to hereinafter.

If the variable j is smaller than the numerical value N and the numerical value L is indicative of “0”, YES is determined in the step S401 on the assumption that the menu table <menu_tbl>[j] exists under the GUI table <guitbl>[i] but no tree table exists under this menu table <menu_tbl>[j]. Then, the variable i is incremented in the step S403 and the process returns to the step S391. For example, since no tree table exists for 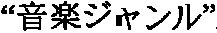
shown in FIG. 9 (A), YES is determined in the step S401 taking note of the GUI table <guitbl>[0].

If the variable j is smaller than the numerical value I and the numerical value L is “1” or more, the process moves from the step S401 to the step 405 to set the address value of *tree_table contained in the menu table <menu_tbl>[j] to the variable tree_tbl. Accordingly, <tree_tbl>[0] to <tree_tbl>[L-1] belonging to the menu table <menu_tbl>[j] under the GUI table <guitbl>[i] are taken note of.

In the step S407, the variable k is set to “0”. In the step S409, the variable k is compared with the numerical value L indicated by tree_maxnum contained in the menu table <menu_tbl>[j]. Then, when the variable k has reached the numerical value L, the variable j is incremented in the step S411, and the process returns to the step S397. If the variable k is smaller than the numerical value L, a process of step S413 and later is carried out.

In the steps S413 and S415, taking note of a tree table tree_tbl[k] belonging to the menu table <menu_tbl>[j] and the GUI table <guitbl>[tree_tbl[k]. gui_tree[0]] managing this tree table tree_tbl[k], a comparison is made between gui_tree of the tree table tree_tbl[k] and GUI_MEMBER of the GUI table <guitbl>[tree_tbl[k]. gui_tree[0]]. More specifically, the 1st byte value of gui_tree and the 1st byte value of GUI_MEMBER are compared with each other in the step S413, and the 2nd byte value of gui_tree and the 2nd byte value of GUI_MEMBER are compared with each other in the step S415.

Then, if the two are not coincident with each other at least in either 1st byte value or 2nd byte value, it is concluded that the tree table tree_tbl[k] is dependent on the GUI table <guitbl>[tree_tbl[k].gui_tree[0]], the variable k is incremented in the step S417, and then the process returns to the step S409. On the contrary, if the two are coincident with each other in both 1st byte value and 2nd byte value, it is concluded that the tree table tree_tbl[k] is dependent on the GUI table <guitbl>[tree_tbl[k]. gui_tree[0]], and the process moves to the step S419. In the large item menu shown in FIG. 9 (A), for example, by selecting 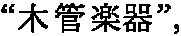
the branch menu number “0” and the small item number “1” are described in GUI_MEMBER of the GUI table <guitbl>[1]. Consequently, the process goes to the step S419 when the tree table <tree_tbl>[1] belonging to the GUI table <guitbl>[2] is taken note of.

In the step S419, an identifier indicative of “selectable” is described in GUI_SELECT contained in the GUI table <guitbl>[i]. The GUI table <guitbl>[i] here is the same as the GUI table <guitbl>[tree_tbl[k]. gui_tree[0]], and thus the identifier indicative of “selectable” is described in GUI_SELECT of the GUI table on which the tree table tree_tbl[k] is dependent.

In the step S421, it is determined whether or not the 0th byte value of gui_tree contained in the tree table <tree_tbl>[k] is equal to the variable back_cnt1. Then, if YES, the process goes to the step S423 to set “−1” to the 1st byte and 2nd byte of GUI_MEMBER contained in the GUI table <guitbl>[i] and describe the identifier indicative of “item unselected” in GUI_PROPERTY contained in the GUI table <guitbl>[i]. Upon completion of the process of step S423, the variable i is incremented in the step S425, and the process returns to the step S391. In contrast, if NO is determined in the step S421, the step S423 is bypassed and the variable i is incremented in the step S425, and then the process returns to the step S391.

The steps S399 and S423 are processed when 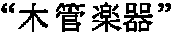
in the large item menu shown in FIG. 9 (B) is changed to 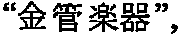
for example. That is, the processes of steps S399 and S423 are carried out by making a transition from the large item menu shown in FIG. 9 (B) to the branch menu shown in FIG. 8 (B) and operating the set key 50 with the cursor CS pointed at 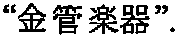
More specifically, the process of step S399 is performed so as not to display the character strings 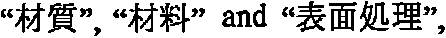
and the process of step S423 is performed so as to change 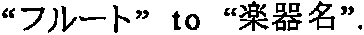
Incidentally, the process of changing from 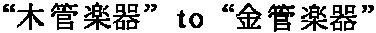
is carried out in the step S387.

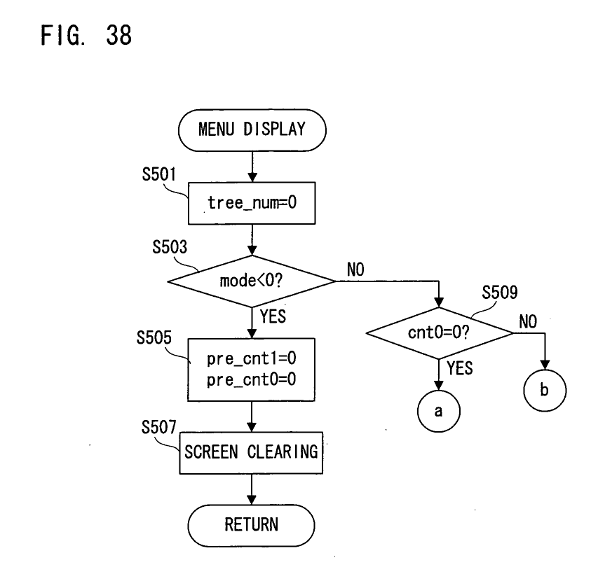

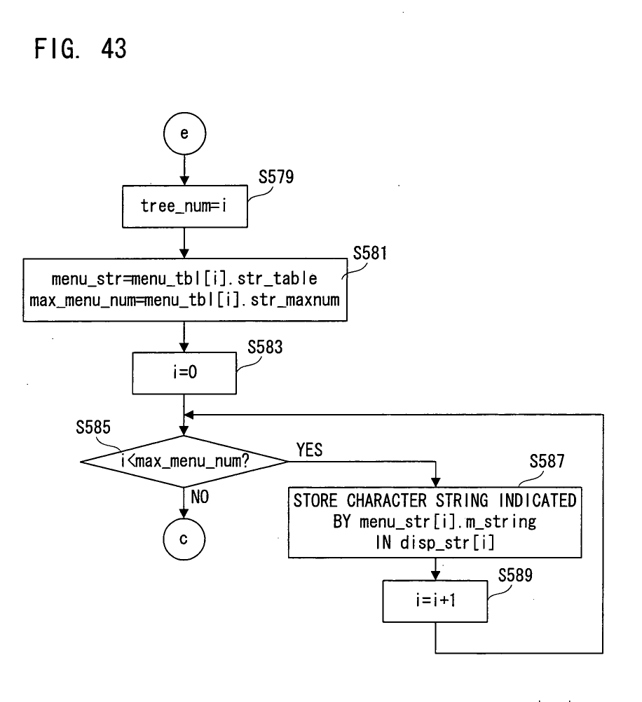

The menu display process in the step S303, S323, S327, S341, S357, S375 or S385 is compliant with the subroutine shown in FIG. 38 to FIG. 43.

Referring to FIG. 38, the variable tree_num is set to “0” in a step S501, and a numerical value indicated by the variable mode is determined in a step S503. If the variable mode is “−1”, that is, if the variable mode denotes clearing of the menu screen, YES is determined in the step S503, the variables pre_cnt1 and pre_cnt2 are set to “0” in the step S505, and the menu screen is cleared in a step S507. Upon completion of the process of step S507, the process returns to a hierarchical upper routine. If the variable mode is “1”, that is, if the variable mode denotes rendering of a menu screen, the process moves from the step S503 to a step S509 to determine a value indicated by the variable cnt0. If the variable cnt0 is “0”, that is, if the variable cnt0 means display of a large item menu, the process goes to a step S511. On the other hand, if the variable cnt0 is “1”, that is, the variable cnt0 means display of a branch menu, the process goes to a step S555.

In the step S511, the numerical value N indicated by LAN_GUI_MUXNUM contained in the LAN table <lantable>[0] is set as a variable max menu_num. In a succeeding step S513, the variables k and i are set to “0”. In a step S515, the variable i is compared with the variable max_menu₁₃ num, i.e., the numerical value N. The processes of steps S517 to S529 are repeatedly performed until the variable i reaches the numerical value N.

In the step S517, an identifier for GUI_VISIBLE contained in the GUI table <guitbl>[i] is determined. If the identifier indicates “undisplayable”, the process moves directly to the step S529, and then returns to the step S515 after incrementation of the variable i. If the identifier indicates “displayable”, an identifier for GUI_PROPERTY contained in the GUI table <guitbl>[i] is determined in the step S519. If this identifier indicates “item unselected”, the process goes to the step S521. If the identifier denotes “item selected” or “item locked”, the process goes to the step S523.

In the step S521, a large item character string specified by *GUI_TABLE contained in the GUI table <guitbl>[i] is extracted from the character string data GUICONF0.DAT, and the extracted character string is stored in the register disp_str[k]. This allows the large item character string to be displayed. Upon completion of the process, the variable k is incremented in the step S527, the variable i is incremented in the step S529, and then the process returns to the step S515.

In the step S523, the address value of *GUI_LINKADR contained in the GUI table <guitbl>[i] is set as the variable menu_tbl, the 1st byte value of GUI_MEMBER contained in the GUI table <guitbl>[i] is set as the variable tree_num, and the address value of *str_table contained in the branch menu table <menu_tbl>[tree_num] is set as the variable menu_str. Therefore, the menu strings <menu_str>[0] to <menu_str>[K-1] under the branch menu table managing the selected small item are taken note of.

In the step S525, a menu string corresponding to the 2nd byte value of GUI_MEMBER contained in the GUI table <guitbl>[i] is specified from the noticed menu strings to be noted <menu_str>[0] to <menu_str>[K-1], a small item character string specified by m_string contained in the specified menu string is extracted from the character string data GUICONF0.DAT, and the extracted character string is stored in the register disp_str[k]. This allows the selected small item character string to be displayed. Upon completion of the process, the variable k is incremented in the step S527, the variable i is incremented in the step S529, and then the process returns to the step S515.

If NO is determined in the step S515, an error check is carried out in steps S531 to S535. In the step S531, it is determined whether or not the variable cnt1 is equal to or larger than the variable max_menu_num, that is, whether or not there is an error in the position of the cursor CS. In the step S533, it is determined whether or not the variable cnt0 is “0” indicative of display of a large item menu and whether or not GUI_SELECT contained in the GUI table <guitbl>[cnt1] has an identifier of “unselectable”. In the step S535, it is determined whether or not GUI_VISIBLE contained in <guitbl>[cnt1] has an identifier of “undisplayable”.

If YES is determined in any one of the steps S531 to S535, it is concluded that an error has occurred, the variable tree_num is set to “−1” in a step S537, and the process returns to a hierarchical upper routine. On the contrary, if NO is determined in all the steps S531 to S535, it is concluded that no error has occurred, and the process moves to a step S539.

In the step S539, the variable i is set to “0”. In a step S541, the variable i is compared with the variable max_menu_num. If the variable i is below the variable max_menu_num, the process moves to a step S543 to display the character string stored in the register disp_str[i] on the i-th line of the screen. Upon completion of the display process, the variable i is incremented in a step S545, and then the process returns to the step S541. When the variable i has reached the variable max_menu_num, the process goes to a step S547 to display the cursor CS so as to point at a character string on a cnt1-th line.

In a step S549, a numerical value indicated by the variable cnt0 is determined. If the variable cnt0 here is “0”, that is, if the variable cnt0 denotes display of a large item menu, the variable cnt1 is set to the variable pre_cnt1 in a step S551, the variable cnt0 is set to the variable pre_cnt0 in a step S553. In contrast, if the variable cnt0 is “1”, that is, the variable cnt0 denotes display of a branch menu, the step S551 is bypassed and the variable cnt0 is set to the variable pre_cnt0 in the step S553. Upon completion of the process of step S553, the process returns to a hierarchical upper routine.

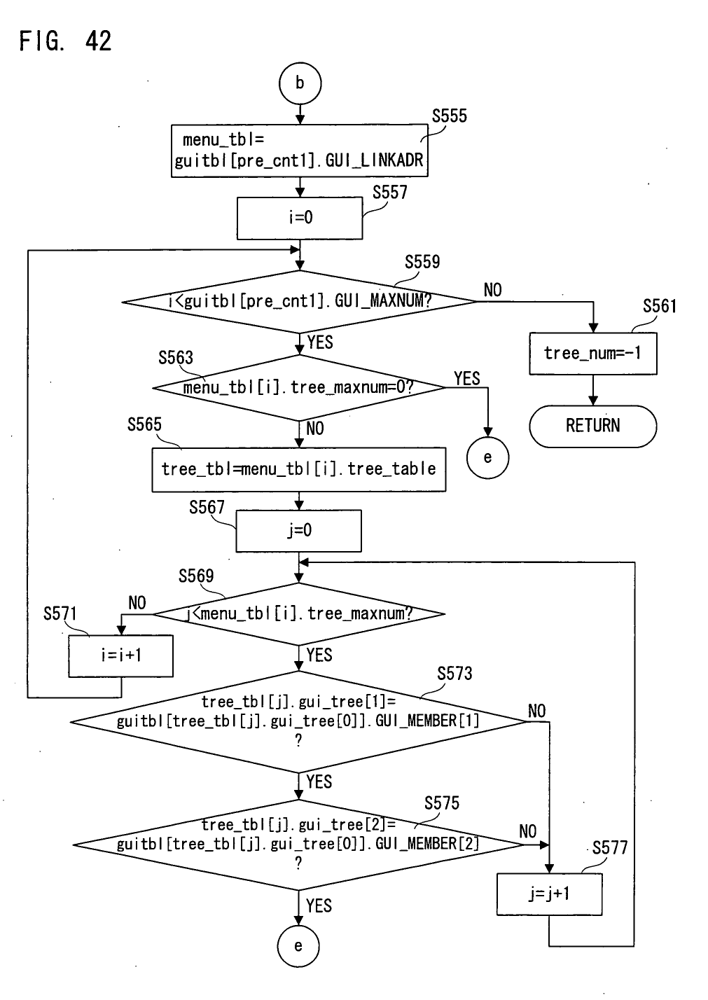

If NO is determined in the step S509 shown in FIG. 38, the process moves to the step S555 shown in FIG. 42 to display a branch menu. In this step, the address value of *GUI_LINKADR contained in the GUI table <guitbl>[pre_cnt1] is set as the variable menu_tbl. With this, the branch menu tables <menu_tbl[0]> to <menu_tbl[N-1]> belonging to the GUI table <guitbl[pre_cnt1]> are taken note of. In a step S557, the variable i is set to “0”. In a step S559, the variable i is compared with the numerical value I indicated by GUI_MAXNUM contained in the GUI table <guitbl[pre_cnt1]>. Then, if the variable i is below the numerical value I, a process of a step S563 and later is carried out. When the variable i has reached the numerical value I, it is concluded that an error has occurred, the variable tree_num is set to “−1” in the step S561, and then the process returns to a hierarchical upper routine.

In the step S563, the numerical value L indicated by tree_maxnum of the noticed branch menu table <menu_tbl[i]> is determined. If the numerical value L is “0”, it is concluded that no tree table exists under the noticed branch menu table <menu_tbl[i]>, and the process moves directly to a step S577. If the numerical value L is “1” or more, it is concluded that there exist tree tables <tree_tbl>[0] to <tree_tbl>[L-1] under the noticed branch menu table <menu_tbl>[i], and the process goes to a step S565 to search for a tree table dependent on the selected branch menu.

In the step S565, the address value of *tree table contained in the branch menu table <menu_tbl>[i] is set as the variable tree_tbl. Therefore, the tree tables <tree_tbl>[0] to <tree_tbl>[L-1] belonging to the branch menu table <menu_tbl>[i] are taken note of. In a step S567, the variable j is set to “0”. In a step S569, the variable j is compared with the numerical value L indicated by tree_maxnum of the branch menu table <menu_tbl>[i]. If the variable j has reached the numerical value L, the variable i is incremented in a step S571, and the process returns to the step S559. If the variable j is below the numerical value L, the same processes as the above mentioned steps S413 and S415 are carried out in steps S573 and S575.

If NO is determined in either the step S573 or S575, it is concluded that the tree table tree_tbl[] is not dependent on the GUI table <guitbl>[tree_tbl[j]. gui_tree[0]], the variable j is incremented in a step S577, and then the process returns to the step S569. On the contrary, if YES is determined in both the steps S573 and S575, it is concluded that the tree table tree_tbl[k] is dependent on the GUI table <guitbl>[tree_tbl[k]. gui_tree[0]], and the process moves to a step S579.

In the step S579, the variable i is set to the variable tree_num to validate the number for the selected branch menu. In a step S581, the address value of *str_table contained in the branch menu table <menu_tbl>[i] is set as the variable menu_str, the numerical value K indicated by str_maxnum of the branch_menu table <menu_tbl>[i] is set as the variable max_menu_num. With this, the menu strings <menu_str>[0] to <menu_str>[K-1] belonging to the branch menu table <menu_tbl>[i] are taken note of.

In a step S583, the variable i is set to “0”. In a step S585, the variable i is compared with the variable max_menu_num, that is, the numerical value K. If the variable i is below the numerical value K, the process moves to a step S587 to store a character string specified by *menu_string of the menu strings <menu_str>[i] in the register disp_str[i]. Upon completion of this process, the variable i is incremented in a step S589, and the process returns to the step S585. When the variable i has reached the numerical value K, the process moves to the step S531.

As understood from the above description, the display control table GUICONF0.TBL read out by the CPU 44 comprises a plurality of GUI tables <guitbl>[0] to <guitbl>[N-1] and a plurality of menu tables <menu_tbl>[0] to <menu_tbl>[I-1] belonging to each of the GUI tables. Each of the GUI tables <guitbl>[0] to <guitbl>[N-1] manages a plurality of large items subjected to a display process by the CPU 44. Also, each of the menu tables <menu_tbl>[0] to <menu_tbl>[I-1] manages a plurality of small items subjected to a display process by the CPU 44.

Assigned to each of the menu tables <menu_tbl>[0] to <menu_tbl>[I-1] are tree tables <tree_tbl>[0] to <tree_tbl>[L-1] indicative of dependency relationships with small items managed under another GUI table which is different from the GUI table to which the menu table itself belongs. When a desired small item is selected, the CPU 44 displays a plurality of small items dependent on the desired small item, based on these tree tables <tree_tbl>[0] to <tree_tbl>[L-1].

In this manner, the tree tables <tree_tbl>[0] to <tree_tbl>[L-1] are assigned to each of the menu tables <menu_tbl>[0] to <menu_tbl>[I-1], which allows the CPU 44 to precisely display small items on the screen. That is, the digital camera 10 can display different menu images on the screen by a common procedure.

In addition, the branch menu number and small item number indicative of the desired small item, that is, the desired small item information is described as GUI_MEMBER in the GUI table managing the desired small item. The CPU 44 displays the desired small item instead of the large item corresponding to the desired small item, based on the desired small item information. This makes it possible to easily understand which small item is selected, thereby increasing the operability. Incidentally, a plurality of tree tables can be assigned to a menu table, which allows the total number of menu tables and the size of data to be decreased.

Moreover, when the desired small item is deselected, the branch menu number and small item number described in GUI_MEMBER are switched to “−1” indicative of item unselected. The processor displays a large item corresponding to the desired small item instead of the desired small item, based on the small item unselected information.

Furthermore, the identifier indicative of “unselectable”, that is, unselectable information is described in GUI_SELECT of the GUI table to which a menu table dependent on small items in the menu table with no desired small item selected belongs. The CPU 44 stops displaying the large items managed by the GUI table to which the unselectable information is assigned. This stops display of the large items related to the unselected small item, which leads to an improvement in operability.

In addition, the plurality of menu tables <menu_tbl>[0] to <menu_tbl>[I-1] belonging to each of the GUI tables <guitbl>[0] to <guitbl>[N-1] forms a sequence, and *GUI_LINKADR and GUI_MAXNUM are described in each of the GUI tables <guitbl>[0] to <guitbl>[N-1]. This eliminates the need for describing address information for each menu table, resulting in a data size reduction.

Besides, in this embodiment, the memory card 38 and the communication card 40 are selectively attached to the slot 36. Preparing a dual slot allows the memory card 38 and the communication card 40 to be simultaneously attached. Also, preparing a memory card with a communication capability achieves a memory capability and communication capability together with a single slot.

Additionally, in this embodiment, the display control table GUICONF0.TBL and the character string data GUICONF0.DAT, and an image file in a condition where communications are impossible are stored in the built-in flash memory 42. With such a dual slot as mentioned above, however, these data may be stored in the memory card 38. By preparing a memory card with a communication capability, these data may be stored in the memory card with a communication capability.

Moreover, this embodiment supposes menu images suitable for inputting detailed information on a manufacturing site of musical instruments. Alternatively, preparing menu images for inputting detailed information on a building construction site would make it possible to obtain a digital camera for construction companies. In addition, preparing menu images for inputting detailed information on a traffic accident site would realize a digital camera for damage insurance companies.

Furthermore, a description of this embodiment is given with use of a digital camera, but it is needless to say that the present invention is applicable to every kind of electronic equipment displaying menu images.

Although the present invention has been described and illustrated in detail, it is clearly understood that the same is by way of illustration and example only and is not to be taken by way of limitation, the spirit and scope of the present invention being limited only by the terms of the appended claims.

1. A data structure of menu display control data which is read out by a processor of a display device displaying a menu image, comprising:
a plurality of first management tables each of which manages a plurality of large items to be subjected to a display process by said processor; and
a plurality of second management tables which belong to each of said plurality of first management tables and each of which manages a plurality of small items to be subjected to a display process by said processor, wherein
dependency relationship information indicative of dependence on a small item managed under a first management table different from the first management table to which a noticed second management table belongs is assigned to said noticed second management tale, so that, when a desired small item is selected, said processor can display a plurality of small items dependent on said desired small item, based on said dependency relationship information.

2. A data structure according to claim 1, wherein desired small item information indicative of said desired small item is assigned to the first management table managing said desired small item, so that said processor can display said desired small item instead of a large item corresponding to said desired small item, based on said desired small item information.

3. A data structure according to claim 2, wherein said desired small item information is switched to small item unselected information when said desired small item is deselected, so that said processor can display the large item corresponding to said desired small item instead of said desired small item, based on said small item unselected information.

4. A data structure according to claim 1, wherein unselectable information is assigned to the first management table to which a second management table dependent on a small item of the second management table in which said desired small item is not selected belongs, so that said processor can suspend display of the large items managed by the first management table to which said unselectable information is assigned.

5. A data structure according to claim 1, wherein the plurality of second management tables belonging to each of said plurality of the first management tables form a sequence, and leading position information and number-of-tables information of said plurality of second management tables are assigned to each of said plurality of the first management tables.

6. A data structure according to claim 1, wherein said dependency relationship information can be indicative of dependency relationships with a plurality of small items.

7. A data file storing menu display control data according to claim 1.

8. A menu display device comprising a display means for displaying a menu image based on menu display control data, wherein
said menu display control data includes a plurality of first management tables which each manage a plurality of large items and a plurality of second management tables which belong to each of said plurality of first management tables and each of which manages a plurality of small items, each of said plurality of second management tables is assigned to dependency relationship information indicative of dependence on a small item under a first management table different from the first management table to which the second management table belongs, and
said display means includes a specifying means which, when a desired small item is selected, specifies a plurality of small items dependent on said desired small item, based on said dependency relationship information.

9. A menu display device according to claim 8, wherein
said display means further includes a first assigning means for assigning desired small item information indicative of said desired small item to the first management table managing said desired small item, and a small item display means for displaying said desired small item instead of a large item corresponding to said desired small item based on said desired small item information.

10. A menu display device according to claim 9, wherein said display means further includes a switching means for making a switch from said desired small item information to small item unselected information when said desired small item is deselected, and a large item display means for displaying the large item corresponding to said desired small item instead of said desired small item, based on said small item unselected information.

11. A menu display device according to claim 8, wherein said display means further includes a second assigning means for assigning unselectable information to a first management table to which a second management table dependent on the small items of the second management table in which said desired small item is not selected, and a suspending means for suspending display of large items managed by the first management table to which said unselectable information is assigned.

12. A menu display device according to claim 8, further comprising:
a photographing means for photographing an object; and
a creating means for creating an image file containing an image signal of the object photographed by said photographing means and menu information including said desired small item.

13. A data file storing menu display control data according to claim 2.

14. A data file storing menu display control data according to claim 3.

15. A data file storing menu display control data according to claim 4.

16. A data file storing menu display control data according to claim 5.

17. A data file storing menu display control data according to claim 6.
